(19) United States
(12) Patent Application Publication
(10) Pub. No.: US 2012/0081287 A1
(43) Pub. Date: Apr. 5, 2012

(54) MOBILE TERMINAL AND APPLICATION CONTROLLING METHOD THEREIN

(76) Inventors: Kanguk KIM, Anyang-si (KR); Kyunglang Park, Gwangmyeong-si (KR)

(21) Appl. No.: 13/083,254

(22) Filed: Apr. 8, 2011

(30) Foreign Application Priority Data
Oct. 1, 2010 (KR) 10-2010-0095760

(51) Int. Cl. G06F 3/02

(52) U.S. Cl. 345/168

(57) ABSTRACT

A mobile terminal including a display unit configured to display information related to the mobile terminal; a wireless communication unit configured to wirelessly communicate with an external application executing device via a wireless communication network; a memory configured to store at least one plug-in data corresponding to a specific application; and a controller configured to execute the plug-in data and to control the specific application to be executed in the external application executing device.

Pursuant to 35 U.S.C. §119(a), this application claims the benefit of earlier filing date and right of priority to Korean Application No. 10-2010-0095760, filed on Oct. 1, 2010, the contents of which are hereby incorporated by reference herein in their entirety.

### BACKGROUND OF THE INVENTION

1. Field of the Invention

The present invention relates to a mobile terminal and corresponding method for controlling applications executing on another device.

2. Discussion of the Related Art

Generally, terminals can be classified into mobile/portable terminals and stationary terminals. Further, mobile terminals can be classified into handheld terminals and vehicle mounted terminals. As functions of the terminal are diversified, the terminal is implemented as a multimedia player provided with composite functions such as photographing of photos or moving pictures, playback of music or moving picture files, game play, broadcast reception, etc.

However, the mobile terminal is generally operating as a single device, and does not sufficiently interface with electronic devices interoperating with the terminal.

### SUMMARY OF THE INVENTION

Accordingly, one object of the present invention is to provide a mobile terminal and application controlling method therein that substantially obviate one or more problems due to limitations and disadvantages of the related art.

Another object of the present invention is to provide a mobile terminal and corresponding method for controlling another device via the mobile terminal.

To achieve these objects and other advantages and in accordance with the purpose of the invention, as embodied and broadly described herein, the present invention provides in one aspect a mobile terminal including a display unit configured to display information related to the mobile terminal; a wireless communication unit configured to wirelessly communicate with an external application executing device via a wireless communication network; a memory configured to store at least one plug-in data corresponding to a specific application; and a controller configured to execute the plug-in data and to control the specific application to be executed on the external application executing device.

In another aspect, the present invention provides a method of controlling a mobile terminal, and which includes wirelessly communicating, via a wireless communication unit of the mobile terminal, with an external application executing device via a wireless communication network; storing, in a memory of the mobile terminal, at least one plug-in data corresponding to a specific application; executing, via a controller of the mobile terminal, the plug-in data; and executing, via the controller, the specific application on the external application executing device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of the present invention;

FIG. 2 is a front perspective diagram of a mobile terminal according to an embodiment of the present invention;

FIG. 3 is a rear perspective diagram of a mobile terminal according to an embodiment of the present invention;

FIG. 4 is a diagram of a mobile terminal and application executing devices according to an embodiment of the present invention;

FIG. 5 is a flow diagram illustrating an operation of a mobile terminal according to an embodiment of the present invention;

FIG. 6 is an overview of a display screen configuration of a mobile terminal according to another embodiment of the present invention;

FIGS. 7 to 9 are overviews of another display screen configuration of a mobile terminal according to an embodiment of the present invention;

FIG. 10 is an overview of a display screen configuration output by an application executing device controlled by a mobile terminal according to an embodiment of the present invention;

FIGS. 11 and 12 are overviews of a display screen configuration of a mobile terminal according to another embodiment of the present invention;

FIGS. 13 to 15 are overviews of a display screen configuration of a mobile terminal according to yet another embodiment of the present invention;

FIG. 16 is an overview of another display screen configuration output by an application executing device controlled by a mobile terminal according to an embodiment of the present invention;

FIG. 17 is an overview of another display screen configuration of a mobile terminal according to an embodiment of the present invention;

FIG. 18 is an overview of another display screen configuration output by an application executing device and another display screen configuration output from a mobile terminal to correspond to the display screen configuration of the application executing device;

FIG. 19 is an overview of another display screen configuration of a mobile terminal according to an embodiment of the present invention;

FIGS. 20 and 21 are overviews of another display screen configuration of a mobile terminal according to an embodiment of the present invention;

FIG. 22 is an overview of a display screen configuration output by an application executing device controlled by a mobile terminal according to an embodiment of the present invention;

FIG. 23 is an overview of another display screen configuration of a mobile terminal according to an embodiment of the present invention;

FIG. 24 is an overview of a display screen configuration output by an application executing device controlled by a mobile terminal according to an embodiment of the present invention;

FIG. 25 is an overview of a display screen configuration output by an application executing device controlled by a mobile terminal according to an embodiment of the present invention;

FIG. 26 is an overview of another display screen configuration output by a mobile terminal according to an embodiment of the present invention to correspond to the former display screen configuration shown in FIG. 25;

FIGS. 27 and 28 are overviews of a display screen configuration of a mobile terminal according to yet another embodiment of the present invention;

FIG. 29 is a flow diagram illustrating an operation of a mobile terminal according to an embodiment of the present invention;

FIG. 30 is an overview for describing interactive operations between a mobile terminal and an application executing device controlled by the mobile terminal according to an embodiment of the present invention;

FIG. 31 is an overview of another display screen configuration output by an application executing device and another display screen configuration output from a mobile terminal to correspond to the display screen configuration of the application executing device;

FIG. 32 is a flowchart illustrating an additional operation of a mobile terminal according to an embodiment of the present invention; and

FIGS. 33 and 34 are flowcharts illustrating a method of controlling an application according to another embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

In addition, mobile terminals described in this disclosure can include a mobile phone, a smart phone, a laptop computer, a digital broadcast terminal, a PDA (personal digital assistants), a PMP (portable multimedia player), a navigation system and the like.

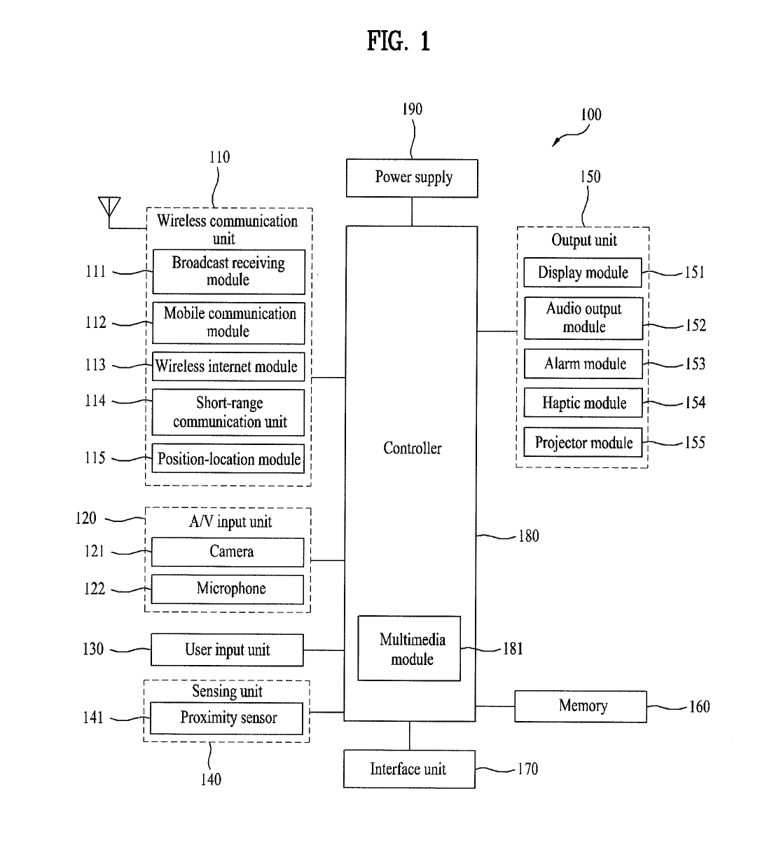

FIG. 1 is a block diagram of the mobile terminal 100 according to an embodiment of the present invention. Referring to FIG. 1, the mobile terminal 100 includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but implementing all of the illustrated components is not a requirement. Greater or fewer components may alternatively be implemented.

Further, the wireless communication unit 110 generally includes one or more components which permits wireless communication between the mobile terminal 100 and a wireless communication system or network within which the mobile terminal 100 is located. For instance, in FIG. 1, the wireless communication unit 110 includes a broadcast receiving module 111, a mobile communication module 112, a wireless internet module 113, a short-range communication module 114, a position-location module 115 and the like.

Further, the wireless communication unit 110 includes a short range communication module 114 and the like to enable wireless communications between the mobile terminal 100 and such an application executing device (e.g., a device capable of running applications) as a personal computer (PC), a notebook computer, a game player, another mobile terminal and the like.

In addition, the broadcast receiving module 111 receives a broadcast signal and/or broadcast associated information from an external broadcast managing server via a broadcast channel. The broadcast channel may include a satellite channel and a terrestrial channel.

Further, the broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

In addition, the broadcast associated information includes information associated with a broadcast channel, a broadcast program, a broadcast service provider, etc. The broadcast associated information can also be provided via a mobile communication network. In this instance, the broadcast associated information can be received by the mobile communication module 112.

The broadcast associated information can also be implemented in various forms. For instance, broadcast associated information may include an electronic program guide (EPG) of the digital multimedia broadcasting (DMB) system and an electronic service guide (ESG) of the digital video broadcast-handheld (DVB-H) system.

The broadcast receiving module 111 may also be configured to receive broadcast signals transmitted from various types of broadcast systems. In a non-limiting example, such broadcasting systems include the digital multimedia broadcasting-terrestrial (DMB-T) system, the digital multimedia broadcasting-satellite (DMB-S) system, the digital video broadcast-handheld (DVB-H) system, the data broadcasting system known as the media forward link only (MediaFLO®) and the integrated services digital broadcast-terrestrial (ISDB-T). The broadcast receiving module 111 can also be configured suitable for other broadcasting systems as well as the above-explained digital broadcasting systems.

Further, the broadcast signal and/or broadcast associated information received by the broadcast receiving module 111 may be stored in a suitable device, such as a memory 160. Also, the mobile communication module 112 transmits/receives wireless signals to/from one or more network entities (e.g., base station, external terminal, server, etc.). Such wireless signals may represent audio, video, and data according to text/multimedia message transceivings, among others.

In addition, the wireless Internet module 113 supports Internet access for the mobile terminal 100 and may be internally or externally coupled to the mobile terminal 100. The wireless Internet technology can include WLAN (Wireless LAN) (Wi-Fi), Wibro (Wireless broadband), Wimax (World Interoperability for Microwave Access), HSDPA (High Speed Downlink Packet Access), GPRS (General Packet Radio Service), CDMA, WCDMA, LTE (Long Term Evolution), etc.

Meanwhile, the wireless internet module by WiFi can be called a WiFi module. In addition, when the wireless internet access by one of Wibro, HSPDA, GPRS, CDMA, WCDMA, LTE and the like is basically established via a mobile communication network, the wireless Internet module 113 performing the wireless Internet access via the mobile communication network can be considered part of the mobile communication module 112.

Further, the short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

In addition, the position-location module 115 identifies or otherwise obtains the location of the mobile terminal 100. This module may be implemented with a global positioning system (GPS) module. Further, the GPS module 115 calculates information on distances spaced apart from at least three satellites and precise time information and can then accurately calculate current position information based on at least one of longitude, latitude, altitude and direction by applying triangulation to the calculated information. In particular, a method of calculating position and time information using three satellites and then correcting errors of the calculated position and time information using another satellite is used. The GPS module 115 can also calculate speed information by continuing to calculate a current position in real time.

Further, the audio/video (AN) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode, and the processed image frames can be displayed on the display unit 151.

The image frames processed by the camera 121 can also be stored in the memory 160 or can be externally transmitted via the wireless communication unit 110. Optionally, at least two cameras 121 can be provided to the mobile terminal 100.

Further, the microphone 122 receives an external audio signal while the portable device is in a particular mode, such as phone call mode, recording mode and voice recognition. This audio signal is then processed and converted into electric audio data, and transformed into a format transmittable to a mobile communication base station via the mobile communication module 112 for a call mode. The microphone 122 may also include assorted noise removing algorithms to remove noise generated when receiving the external audio signal.

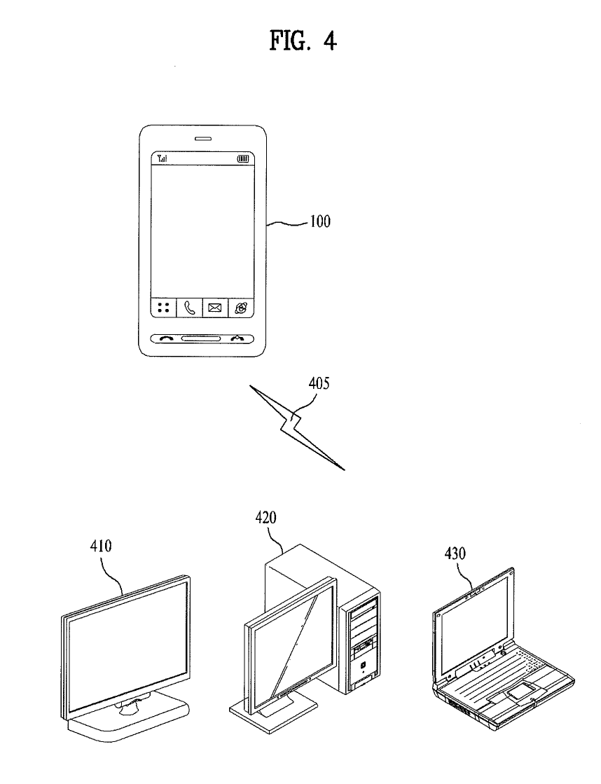

An audio signal input to the microphone 122 can also include a voice signal. In particular, when receiving an input of a control command by voice recognition, the microphone 122 receives an input of a voice signal from a user, processes the input voice signal into voice data, and then transmits the voice data to the controller 180. In this instance, the control command can include a command or request for controlling an operation of the mobile terminal 100. Alternatively, the control command can include a request or command for controlling an application executed operation of an application executing device (e.g., a device 410, 420 or 430 shown in FIG. 4) connected to the mobile terminal 100 via a wireless communication network.

The user input unit 130 also generates input data responsive to user manipulation of an associated input device or devices. Examples of such devices include a keypad, a dome switch, a touchpad (e.g., static pressure/capacitance), a jog wheel, a jog switch, etc. In addition, the sensing unit 140 provides sensing signals for controlling operations of the mobile terminal 100 using status measurements of various aspects of the mobile terminal.

For instance, the sensing unit 140 may detect an opened/closed status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. As an example, when the mobile terminal 100 is configured as a slide-type mobile terminal, the sensing unit 140 can sense whether a sliding portion of the mobile terminal 100 is opened or closed. Other examples include the sensing unit 140 sensing the presence or absence of power provided by the power supply 190, the presence or absence of a coupling or other connection between the interface unit 170 and an external device. In FIG. 1, the sensing unit 140 also includes a proximity sensor 141.

Further, the output unit 150 generates outputs relevant to the senses of sight, hearing, touch and the like. In addition, the output unit 150 includes the display unit 151, an audio output module 152, an alarm unit 153, a haptic module 154, a projector module 155 and the like.

The display unit 151 is implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display unit 151 may additionally or alternatively display images which are associated with these modes, the UI or the GUI.

The display unit 151 can also display a user interface (UI) or a graphic user interface (GUI) for controlling at least one application executing device connected via a wireless communication network of the ireless communication unit 110. In particular, the display unit 151 can display a user interface (UI) or a graphic user interface (GUI) including a control key set having at least one or more control keys for controlling a prescribe application executed in the application executing device.

The display module 151 may also be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can also be implemented in a transparent or optical transmittive type, which are called a transparent display. As a representative example for the transparent display, there is the TOLED (transparent OLED) or the like. A rear configuration of the display unit 151 can also be implemented in the optical transmittive type as well. In this configuration, a user can see an object in rear of a terminal body via the area occupied by the display unit 151 of the terminal body.

Further, at least two display units 151 can be provided to the mobile terminal 100. For instance, a plurality of display units can be arranged on a single face of the mobile terminal 100 in a manner of being spaced apart from each other or being built in one body. Alternatively, a plurality of display units can be arranged on different faces of the mobile terminal 100.

When the display unit 151 and a sensor for detecting a touch action (hereinafter called ‘touch sensor’) configures a mutual layer structure (hereinafter called ‘touchscreen’), the display unit 151 can be used as an input device as well as an output device. In this instance, the touch sensor can be configured as a touch film, a touch sheet, a touchpad or the like.

Further, the touch sensor can be configured to convert a pressure applied to a specific portion of the display unit 151 or a variation of a capacitance generated from a specific portion of the display unit 151 to an electric input signal. Moreover, the touch sensor can be configured to detect a pressure of a touch as well as a touched position or size.

If a touch input is made to the touch sensor, signal(s) corresponding to the touch is transferred to a touch controller. The touch controller then processes the signal(s) and transfers the processed signal(s) to the controller 180. Therefore, the controller 180 can know whether a prescribed portion of the display unit 151 is touched.

Referring to FIG. 1, the proximity sensor 141 can be provided to an internal area of the mobile terminal 100 enclosed by the touchscreen or around the touchscreen. The proximity sensor 141 is a sensor that detects a presence or non-presence of an object approaching a prescribed detecting surface or an object existing around the proximity sensor 141 using an electromagnetic field strength or infrared ray without mechanical contact. Hence, the proximity sensor 141 has durability longer than that of a contact type sensor and also has utility wider than that of the contact type sensor.

The proximity sensor 141 can also include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. When the touchscreen includes the electrostatic capacity proximity sensor, the touchscreen can detect the proximity of a pointer using a variation of electric field according to the proximity of the pointer. In this instance, the touchscreen (touch sensor) can be classified as the proximity sensor 141.

In the following description, for clarity, an action that a pointer approaches without contacting with the touchscreen to be recognized as located on the touchscreen is named ‘proximity touch’. And, an action that a pointer actually touches the touchscreen is named ‘contact touch’. The meaning of the position on the touchscreen proximity-touched by the pointer also means the position of the pointer which vertically opposes the touchscreen when the pointer performs the proximity touch.

The proximity sensor 141 also detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be output to the touchscreen.

Further, the audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 can also be implemented using one or more speakers, buzzers, other audio producing devices, and combinations thereof.

Further, the alarm unit 153 can output a signal for announcing the occurrence of a particular event associated with the mobile terminal 100. Typical events include a call received event, a message received event and a touch input received event. The alarm unit 153 can also output a signal for announcing the event occurrence using vibration as well as video or audio signal. Further, the video or audio signal can be output via the display unit 151 or the audio output unit 152. Hence, the display unit 151 or the audio output module 152 can be regarded as a part of the alarm unit 153.

In addition, the haptic module 154 generates various tactile effects that can be sensed by a user. Vibration is a representative one of the tactile effects generated by the haptic module 154. A strength and pattern of the vibration generated by the haptic module 154 can also be controlled. For instance, different vibrations can be output by being synthesized together or can be output in sequence.

The haptic module 154 can also generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can also be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

Further, the projector module 155 is the element for performing an image projector function using the mobile terminal 100. The projector module 155 can display an image, which is identical to or partially different at least from the image displayed on the display unit 151, on an external screen or wall according to a control signal of the controller 180.

In particular, the projector module 155 can include a light source generating light (e.g., a laser) for projecting an image externally, an image producing device for producing an image to output externally using the light generated from the light source, and a lens for enlarging the image in a predetermined focus distance. In addition, the projector module 155 can further include a device for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display. In particular, the DLP module is operated by the mechanism of enabling the light generated from the light source to reflect on a DMD (digital micro-mirror device) chip and can be advantageous for the downsizing of the projector module 151. Preferably, the projector module 155 is provided in a length direction of a lateral, front or backside direction of the mobile terminal 100. The projector module 155 can also be provided to any portion of the mobile terminal 100.

The memory unit 160 is also generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. A recent use history or a cumulative use frequency of each data (e.g., use frequency for each phonebook, each message or each multimedia) can also be stored in the memory unit 160. Moreover, data for various patterns of vibration and/or sound output for a touch input to the touchscreen can be stored in the memory unit 160.

Various kinds of data required for operations of the mobile terminal 100 can also be stored in the memory 160. In particular, the memory 160 can store at least one plug-in data corresponding to an application. In this instance, the plug-in data includes a plug-in program. The plug-in data is also the program data enabling a host application program to be automatically run in a manner of mutually responding to the host application program. Further, the plug-in can be designed in various ways of methods and types according to a corresponding host application program.

In this instance, the plug-in data includes a plug-in program corresponding to an application executable in the mobile terminal 100 or such an application executing device as a personal computer (PC), a notebook computer, a mobile terminal, a digital television (DTV) and the like.

For instance, assuming that a digital television capable of communicating with the mobile terminal 100 via wireless communication is able to execute a car racing game of a prescribed application, the mobile terminal 100 enables plug-in data of the car racing game to be stored in the memory 160. Subsequently, the controller 180 reads and executes the plug-in data of the car racing game stored in the memory 160 and then controls the car racing game to be automatically executed in the digital television.

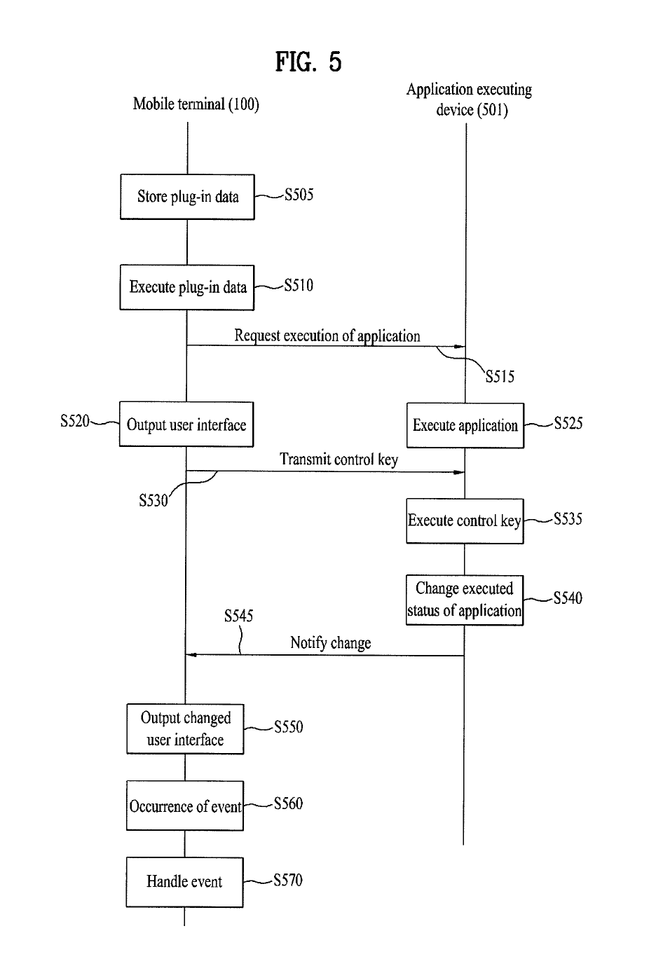

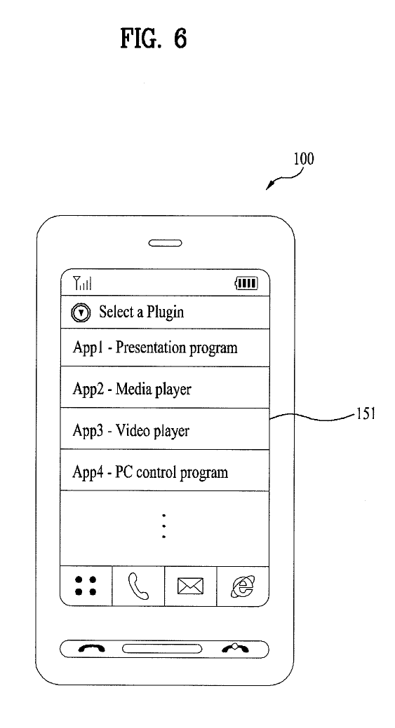

The plug-in data stored in the memory 160 can also include a control key set corresponding to a prescribed application. In particular, the control key set can include various kinds of control keys required for controlling or operating a prescribe application. For instance, if a prescribed application is a car racing game, the control keys required for playing the car racing game can include a left turn key, a right turn key, a forward driving key, a backward driving key, a stop key and the like. Thus, the control key set can include theses control keys and the plug-in data can include the control key set. The plug-in data stored in the memory 160 will be described in detail with reference to FIGS. 5 and 6 later.

Further, the memory 160 may be implemented using any type or combination of suitable volatile and non-volatile memory or storage devices including a hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. Further, the mobile terminal 100 can operate in association with a web storage for performing a storage function of the memory 160 on the Internet.

In addition, the interface unit 170 can be used to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may also be configured using a wired/wireless headset port, an external charger port, a wired/wireless data port, a memory card port, a port for coupling to a device having an identity module, audio input/output ports, video input/output ports, an earphone port and/or the like.

In addition, the identity module is a chip for storing various kinds of information for authenticating a use authority of the mobile terminal 100 and can include a User Identify Module (UIM), Subscriber Identify Module (SIM), Universal Subscriber Identity Module (USIM) and/or the like. A device having the identity module (hereinafter called ‘identity device’) can also be manufactured as a smart card. Therefore, the identity device is connectible to the mobile terminal 100 via the corresponding port.

Thus, when the mobile terminal 110 is connected to an external cradle, the interface unit 170 becomes a passage for supplying the mobile terminal 100 with power from the cradle or a passage for delivering various command signals input from the cradle by a user to the mobile terminal 100. Each of the various command signals input from the cradle or the power can also operate as a signal enabling the mobile terminal 100 to recognize that it is correctly loaded in the cradle.

Further, the controller 180 controls the overall operations of the mobile terminal 100. For example, the controller 180 performs the control and processing associated with voice calls, data communications, video calls, etc. In FIG. 1, the controller 180 includes a multimedia module 181 that provides multimedia playback. The multimedia module 181 may be configured as part of the controller 180, or implemented as a separate component.

Moreover, the controller 180 can perform a pattern recognizing process for recognizing a writing input and a picture drawing input carried out on the touchscreen as characters or images, respectively. In particular, the controller 180 executes a prescribed plug-in data among at least one or more plug-in data stored in the memory 160 and then controls an application corresponding to the plug-in data to be executed in a prescribed application executing device. In this instance, the prescribed application executing device is one of at least one or more application executing devices connected to the mobile terminal 100 via the wireless communication network. Also, the application executing device can transceive prescribed data or control commands with the mobile terminal 100 via the wireless communication network.

If the plug-in data is executed, the controller 180 can the display unit 151 to display a user interface (UI) including a control key set included in the plug-in data. A user can then use a touchscreen function to input a prescribed control key via the displayed control key set. The controller 180 can also control a command or operation corresponding to the input control key to be executed in the application executing device. Detailed operations of the controller 180 shall be described with reference to FIG. 5 later.

In addition, the power supply unit 190 provides power required by the various components for the mobile terminal 100. The power may be internal power, external power, or combinations thereof.

In addition, various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

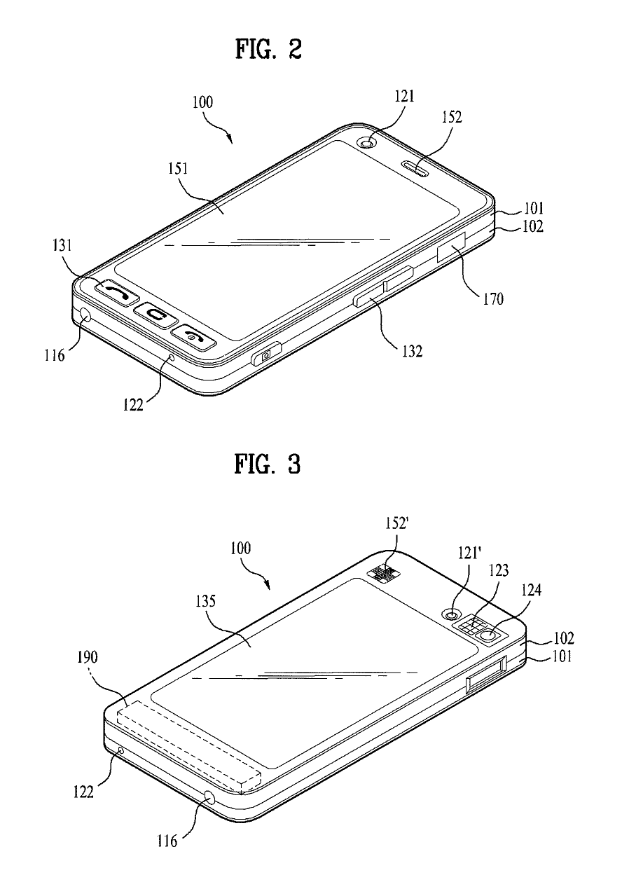

Next, FIG. 2 is a front perspective diagram of the mobile terminal 100 according to an embodiment of the present invention. The mobile terminal 100 shown in the drawing has a bar type terminal body, however, the mobile terminal 100 may be implemented in a variety of different configurations. Examples of such configurations include a folder-type, slide-type, rotational-type, swing-type and combinations thereof The following disclosure will primarily relate to a bar-type mobile terminal 100, however such teachings apply equally to other types of mobile terminals.

Referring to FIG. 2, the mobile terminal 100 includes a case (casing, housing, cover, etc.) configuring an exterior thereof In the present embodiment, the case is divided into a front case 101 and a rear case 102. Various electric/electronic parts are also loaded in a space provided between the front and rear cases 101 and 102. Optionally, at least one middle case can be further provided between the front and rear cases 101 and 102. In addition, the cases 101 and 102 are formed by injection molding of synthetic resin or can be formed of metal substance such as stainless steel (STS), titanium (Ti) or the like, for example.

The display unit 151, audio output unit 152, camera 121, user input units 130/131 and 132, microphone 122, interface unit 170 and the like can also be provided to the terminal body, and more particularly, to the front case 101. Further, the display unit 151 occupies most of a main face of the front case 101. The audio output unit 151 and the camera 121 are provided to an area adjacent to one of both end portions of the display unit 151, while the user input unit 131 and the microphone 122 are provided to another area adjacent to the other end portion of the display unit 151. The user input unit 132 and the interface 170 are also provided to lateral sides of the front and rear cases 101 and 102.

In addition, the input unit 130 is manipulated to receive a command for controlling an operation of the terminal 100. In this embodiment, the input unit 130 also includes a plurality of manipulating units 131 and 132, which can be referred to as a manipulating portion and may adopt any mechanism of a tactile manner that enables a user to perform a manipulation action by experiencing a tactile feeling.

Content input by the first or second manipulating unit 131 or 132 can also be diversely set. For instance, such a command as a start, end, scroll and the like can be input to the first manipulating unit 131. Further, a command for a volume adjustment of sound output from the audio output unit 152, a command for a switching to a touch recognizing mode of the display unit 151 or the like can be input to the second manipulating unit 132.

Next, FIG. 3 is a perspective diagram of a backside of the terminal shown in FIG. 2. Referring to FIG. 3, a camera 121′ is additionally provided to a backside of the terminal body, and more particularly, to the rear case 102. The camera 121′ has a photographing direction that is substantially opposite to that of the camera 121 shown in FIG. 2 and may have pixels differing from those of the camera 121.

Preferably, for instance, the camera 121 has low pixels enough to capture and transmit a picture of user's face for a video call, while the camera 121′ has high pixels for capturing a general subject for photography without transmitting the captured subject. Each of the cameras 121 and 121′ can also be installed at the terminal body to be rotated or popped up.

In addition, a flash 123 and a mirror 124 are additionally provided adjacent to the camera 121′. In more detail, the flash 123 projects light toward a subject when photographing the subject using the camera 121′. When a user attempts to take a picture of the user (self-photography) using the camera 121′, the mirror 124 enables the user to view user's face reflected by the mirror 124.

An additional audio output unit 152′ is also provided to the backside of the terminal body. The additional audio output unit 152′ can thus implement a stereo function together with the former audio output unit 152 shown in FIG. 2 and may be used for implementation of a speakerphone mode in talking over the terminal.

In addition, a broadcast signal receiving antenna 124 can be additionally provided to the lateral side of the terminal body as well as an antenna for communication or the like. The antenna 124 constructing a portion of the broadcast receiving module 111 shown in FIG. 1 can also be retractably provided to the terminal body.

A power supply unit 190 for supplying power to the terminal 100 is also provided to the terminal body. The power supply unit 190 can be configured to be built within the terminal body, or can be configured to be detachably connected to the terminal body.

Further, a touchpad 135 for detecting a touch can be additionally provided to the rear case 102. The touchpad 135 can be configured in a light transmittive type like the display unit 151. In this instance, if the display unit 151 is configured to output visual information from both faces, the user can recognize the visual information via the touchpad 135 as well. Also, the information output from both of the faces can be entirely controlled by the touchpad 135. Alternatively, a display can further provided to the touchpad 135 so that a touchscreen can be provided to the rear case 102 as well.

In addition, the touchpad 135 is activated by interconnecting with the display unit 151 of the front case 101. The touchpad 135 can also be provided in rear of the display unit 151 in parallel and can have a size equal to or smaller than that of the display unit 151.

The following description assumes the display module 151 includes a touchscreen. Therefore, a user can touch each point on a user interface menu displayed via the display unit 151, thereby inputting a control key corresponding to the touched point to the controller 180 of the mobile terminal 100.

Next, FIG. 4 is a diagram of the mobile terminal 100 and application executing devices according to an embodiment of the present invention. In addition, various types of application executing devices are currently available as well as mobile terminals. As mentioned in the foregoing description, the application executing devices include mobile terminals, digital televisions, personal computers, notebook computers, personal digital assistants (PDA) and the like.

Further, a prescribed application is the program designed to perform a prescribed type of work. The prescribed applications include music play applications, video play applications, game applications, presentation programs, word processing applications and the like.

Referring to FIG. 4, the mobile terminal 100 can send and receive (transceive) data or commands by being connected to at least one or more application executing devices 410, 420 and 430 via a wireless communication network 405. The data transceiving via the wireless communication network 405 can be performed by the wireless communication unit 110 of the mobile terminal 100.

For example, FIG. 4 illustrates the application executing devices include a digital television 410, a personal computer (PC) 420 and a notebook computer 430. A short range communication network can be use as the wireless communication network 405. In particular, a communication network such as Bluetooth, RFID (radio frequency identification), IrDA (infrared data association), UWB (ultra wideband), ZigBee and the like can be used as the short range communication network.

In particular, the wireless communication network 405 is established between the mobile terminal 100 and each of the application executing devices 410, 420 and 430 to perform radio controls thereon using the mobile terminal 100. For instance, if Bluetooth is used as the wireless communication network, a Bluetooth setting should be set up between the mobile terminal 100 and the corresponding application executing devices 410, 420 and 430 to perform the radio control using the mobile terminal 100.

Next, FIG. 5 is a flow diagram illustrating an operation of the mobile terminal 100 according to an embodiment of the present invention. FIG. 1 will also be referred to throughout the description of this application.

Referring to FIG. 5, the memory 160 of the mobile terminal 100 stores at least one plug-in data corresponding to a prescribed application (S505). In more detail, the plug-in data includes a plug-in program for automatically executing a prescribed application and includes a control key set corresponding to the prescribed application. For instance, the plug-in data can be written as XML (extensible markup language) data and then be compressed. The plug-in data can also be written and compressed by a manufacturer of the mobile terminal 100.

Further, the plug-in data including the control key set provided to the mobile terminal 100 can be flexibly modified to fit the corresponding application. In addition, the plug-in data including the control key set can be provided by a manufacturer of the mobile terminal 100, a user of the mobile terminal 100, a service provider providing an application to the mobile terminal 100, a manufacturer of an application executing device or the like.

As shown in FIG. 5, the controller 180 of the mobile terminal 100 executes the plug-in data corresponding to the prescribed application (S510). In doing so, the execution of the plug-in data can be performed by a user's request. In more detail, FIG. 6 is an overview of a display screen configuration of the mobile terminal 100 according to an embodiment of the present invention.

Referring to FIG. 6, when the user requests a plug-in data be executed, the controller 180 controls the display unit 151 to display a user interface. In addition, as shown in FIG. 6, the user interface allows the user to select a prescribed plug-in data to be executed from at least one plug-in data stored in the memory 160.

That is, FIG. 6 illustrates an example in which the user interface includes a plurality of plug-in data respectively corresponding to a presentation program, a media player, a video player and a PC control program. The user can then select the plug-in data corresponding to the application to execute (e.g., by touching the desired program, using voice commands, using an external key, etc.). If so, the controller 180 recognizes the selection and then executes the selected plug-in data. In the following description, the plug-in data executed in the step S510 will be referred to as a prescribed plug-in data and a corresponding application will be referred to as a prescribed application.

In accordance with the execution request of the prescribed plug-in data (S515), the controller 180 executes the prescribed application in the application executing device 501 (S525). In particular, in step S515, the controller 180 transmits a prescribed application execution request to the application executing device 501 connected via the wireless communication network. Then, in step S525, the application executing device 501 executes the prescribed application.

Moreover, if there are a plurality of the application executing devices 410, 420 and 430 connected to the mobile terminal 100 via the wireless communication network, as shown in FIG. 4, the controller 180 can select at least one application executing device to which a prescribed application execution request will be transmitted. For example, the selection can be made by a user or can be performed according to a self-setting mode of the controller 180.

Further, the execution request S515 and the application execution S525 can also be automatically performed when the prescribed plug-in data is executed in step S510. Moreover, the step of transmitting the execution request to the application executing device from the mobile terminal 100 can be performed by the wireless communication unit 110 (e.g., the short range communication module 114).

As discussed above, when the plug-in data is executed in step S510, the controller 180 displays the user interface, which includes a control key set corresponding to the prescribed application (S520). The user can then touch one of the control keys included in the control key set using the output user interface, thereby enabling the controller 180 to receive an input of the touched control key.

Further, the controller 180 transmits the control key, which has been input via the user interface, to the application executing device (S530). In response to the transmitted control key, the application executing device executes an operation or command requested by the control key (S535).

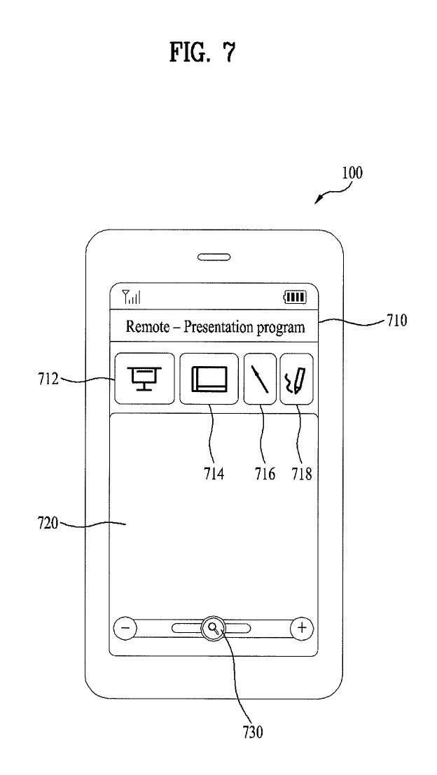

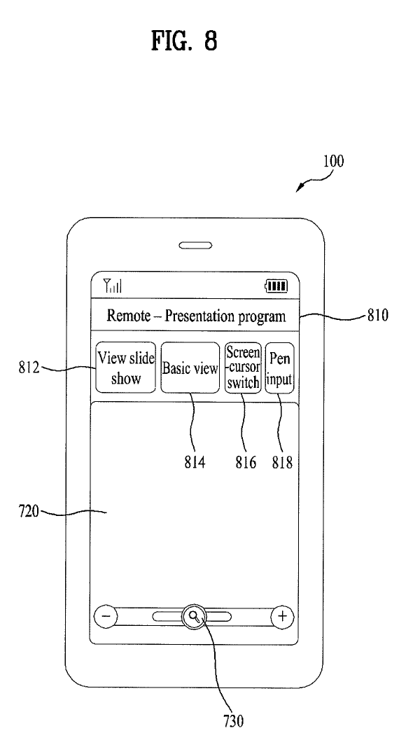

The operation of the mobile terminal 100 described with reference to FIG. 5 will now be explained in more detail with reference to FIGS. 7 to 31. In particular, FIGS. 7 to 9 are overviews of a display screen configuration of the mobile terminal 100 according to an embodiment of the present invention. Also, when a plug-in data corresponding to ‘App1-presentation program’ is selected in FIG. 6 (i.e., if a prescribed application is a presentation program), the display screen shown in FIGS. 7 to 9 is displayed. In particular, FIGS. 7 to 9 show one example of a user interface 710, 810 or 910 including a control key set included in a prescribed plug-in data.

Referring to FIG. 7, in the operation of the step S520 shown in FIG. 5, the controller 180 displays the user interface 710 including a control key set corresponding to a presentation program via the display unit 151. In this instance, the control key set can include control keys required for controlling the presentation program. For instance, the control key set can include at least one of a control key 712 for requesting ‘view slide show’, a control key 714 for requesting a ‘basic view’, a control key 716 for requesting a ‘switch between screen and cursor’, a control key 718 for requesting a ‘pen input’, a touchpad 720, a screen zoom-in/out key 730 and the like.

Further, this example illustrates each of the control keys 712, 714, 716 and 718 being displayed as icons that symbolize the corresponding control keys. In addition, the touchpad 720 can recognize an operation corresponding to a mouse action. In particular, if the user performs a touch & drag on the touchpad 720, a mouse moving action is performed. If the user performs a single or double touch on the touchpad 720, an action of clicking a left button of a mouse is performed. If the user performs a long-touch (e.g., a long-click) on the touchpad 720, an action of clicking a right button of a mouse is performed.

Next, referring to FIG. 8, the controller 180 displays the user interface 810 including a control key set corresponding to a presentation program that is different from the user interface 710 shown in FIG. 7. For instance, control keys 812, 814, 816 and 818 in FIG. 8 are displayed as including text control contents, whereas the control keys 712, 714, 716 and 718 are displayed as icons. Further, the control keys 812, 814, 816 and 818 correspond to the control keys 712, 714, 716 and 718, respectively. Because the user interface 810 shown in FIG. 8 is similar to that of the configuration of the user interface shown in FIG. 7, its details are omitted.

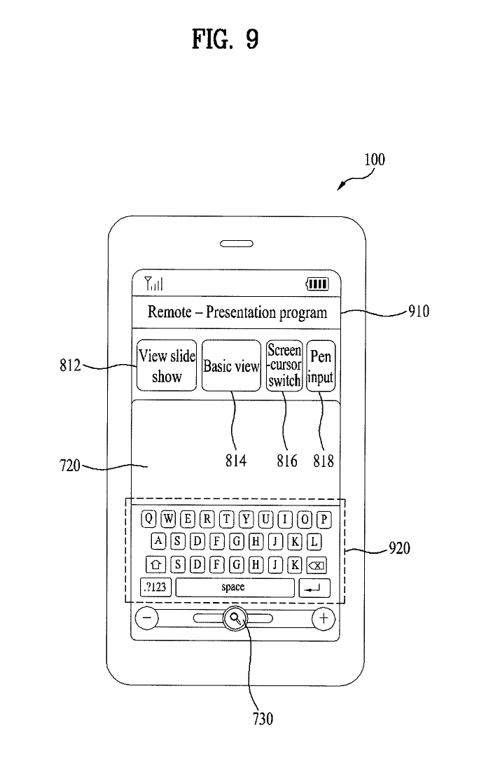

Next, referring to FIG. 9, the controller 180 can also display the user interface 910 including a control key set corresponding to a presentation program that includes additional control keys (e.g., QWERTY keyboard 920) to control the presentation program. Therefore, the user can type or create a document content (e.g., a slide content) to present using the QWERTY keyboard 920.

Thus, as shown in FIGS. 7 to 9, varies control keys can be displayed on the user interface. That is, various types of control keys used for controlling and using a prescribed application (e.g., a presentation program) can be included in the control key set.

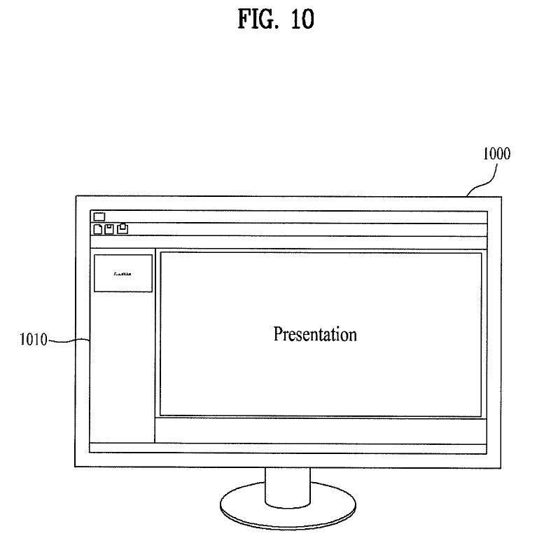

Next, FIG. 10 is an overview of a display screen configuration output by an application executing device 1000 controlled by the mobile terminal 100 according to an embodiment of the present invention. Referring to FIG. 10, the application executing device 1000 (e.g., similar to the application executing device 410 shown in FIG. 4) executes the presentation program and displays a display screen 1010. In particular, FIG. 10 illustrates a slide note for a presentation being output on the display screen 1010. Further, the application executing device 1000 is a digital television, but can also be a personal computer, a notebook computer and the like.

For instance, referring to FIGS. 5, 7 and 10, if the user selects the control key 714 for requesting the ‘basic view’ on the mobile terminal 100 (S530), the controller 180 transmits the control key 714 to the application executing device 1000 to enable an operation corresponding to the control key 714 to be executed in the application executing device 1000. In response to the transmitted control key 714, the application executing device 1000 displays a basic screen (e.g., a slide note) of the presentation on the display screen 1010 (S535).

As mentioned above, the mobile terminal 100 according to one embodiment of the present invention executes the plug-in data to control the prescribed application to be automatically executed in the application executing device 1000. In particular, the prescribed application need not be separately executed in the application executing device 1000. Further, the user advantageously does not need to use a separate remote controller. Further, when the user interface including a control key set corresponding to the prescribed application is output on the mobile terminal 100, the application executed in the application executing device 1000 can be controlled more conveniently.

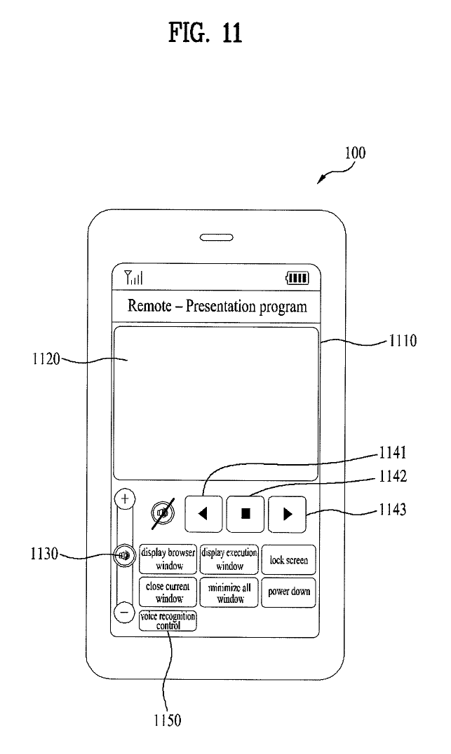

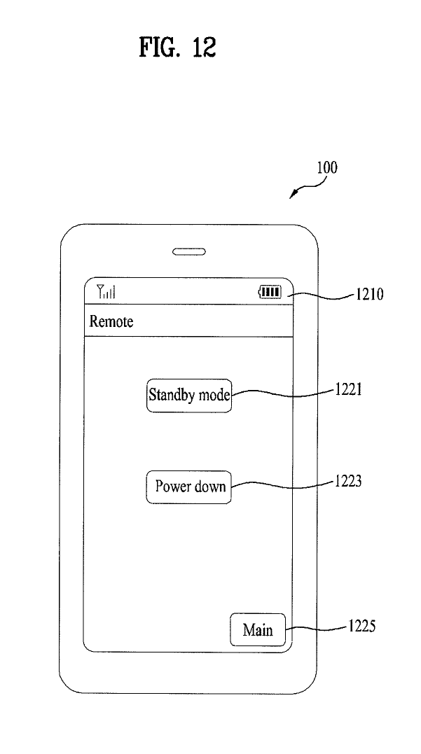

Next, FIGS. 11 and 12 are overviews of a display screen configuration of the mobile terminal 100 according to another embodiment of the present invention. In particular, FIGS. 11 and 12 illustrate a display screen implemented by the mobile terminal 100 when the plug-in data corresponding to ‘App4-PC control program’ is selected in FIG. 6 (i.e., when a prescribed application is a program for controlling a personal computer (PC)).

Referring to FIG. 11, in a manner similar to that shown in FIG. 7, the mobile terminal 100 outputs a user interface 1110 including a control key set corresponding to a PC control program via the display unit 151. The control key set includes control keys used for controlling a personal computer (PC). For instance, the control keys include at least one of a touchpad 1120, a sound adjust key 1130, a previous task shift key 1141, a next task shift key 1143, a task select key 1142, a browser window display key, an execution window display key, a screen lock key, a current window close key, an all-window minimize key, a power down key and the like. Further, the touchpad 1120 is similar to the touchpad 720 shown in FIG. 7.

As the plug-in data corresponding to the PC control system is executed in step S510, the application for the PC control is executed in the personal computer (PC) (i.e., the application executing device) to turn on the personal computer (PC) for the PC control. Also, a wallpaper can be output to a display screen of the personal computer in step S525.

The user interface 1110 can also include a voice recognition control key 1150. In this instance, the voice recognition control key 1150 allows the user to control the personal computer (PC) via voice recognition. In particular, if the voice recognition control key 1150 is selected, the controller 180 of the mobile terminal 100 receives voice data, recognizes a command corresponding to the received voice data using a voice recognition engine provided within the controller 180, and then controls the personal computer (PC) to execute the recognized command. Further, the voice data can include the data converted from a voice signal input via the microphone 122. Alternatively, the voice data can include a voice signal itself input via the microphone 122.

In particular, the controller 180 designates a word corresponding to the control key for controlling the application executing device (e.g., PC 420 in FIG. 4). Afterwards, if the user inputs a prescribed voice signal via the microphone 122, the controller 180 recognizes the voice signal matching the designated word only and performs a control operation according to the recognized voice signal.

For instance, after the voice recognition control key 1150 has been input and when the personal computer (PC) is controlled using a voice recognition function, the controller 180 receives an input of a limited voice signal only, performs the voice recognition on the received input, and then performs a control action corresponding to the input and recognized voice signal.

For example, the controller 180 can designate words of ‘sound strong’, ‘sound weak’, ‘previous’, ‘next’ and ‘select’ as voice signals corresponding to the sound adjust key 1130, the previous task shift key 1141, the next task shift key 1143 and the task select key 1142, respectively. In another example, the controller 180 can designate words of ‘browser’, ‘execute’, ‘screen lock’, ‘current window’, ‘minimize window’ and ‘power down’ as voice signals corresponding to the browser window display key, the execution window display key, the screen lock key, the current window close key, the all-window minimize key and the power down key, which are shown in FIG. 11, respectively. In particular, for instance, if user inputs the voice signal of ‘previous’ via the microphone 122, the controller 180 controls the personal computer (PC) to be shifted to a previous task as if the previous task shift key 1141 is input.

As mentioned above, the controller 180 of the mobile terminal 100 designates a word corresponding to a key for controlling the personal computer (PC), voice-recognizes the designated word only, and can then perform a control operation. Thus, a range of recognizable words is narrowed to further enhance the performance of the voice recognition. Although the present invention illustrates an example in which the voice recognition control key 1150 is included in the user interface 1110 corresponding to the PC control program shown in FIG. 11, the voice recognition control key 1150 can be included in the user interface (e.g., the user interface output in the step S520) to correspond to one of various applications.

After the voice recognition control key 1150 has been input, and the user attempts to search the personal computer (PC) for a prescribed data stored therein using the voice recognition function, the user can enable a search operation for PC data by inputting the voice recognition control key 1150 and the browser window display key in turn. Therefore, the controller 180 of the mobile terminal 100 searches the personal computer (PC) for the prescribed data stored therein using the voice recognition.

In doing so, the controller 180 receives an input of a prescribed voice signal as a search word via the microphone 122, receives an input of a data type limit key for adding a limitation on a range of the search, and can then perform the search within the data type according to the input data type limit key. In this instance, the data type limit key can include each item included in a menu list of the mobile terminal 100. For instance, for the PC data search, the controller 180 can output the menu list of the mobile terminal 100 as a user interface in step S520.

The menu list of the mobile terminal 100 can also include items classified according to a program or data executable in the mobile terminal 100. In particular, items of programs or data stored in the PC are enumerated on the menu list of the mobile terminal 100 and a music button, a file button, an address book button, a picture button, a game button and the like can be included in the menu list.

Also, if a prescribed item included in the menu list of the mobile terminal 100 is selected, the controller 180 can perform the PC data search operation by limiting the search range to the selected and input prescribed item. For instance, if the user presses the music button and then input a voice signal ‘abc’ as a search word to the microphone 122, the controller 180 recognizes the ‘abc’ signal, searches whether a music file, which has the recognized search word of the word ‘abc’ included in a title or content (lyrics) of the music file, exists in the personal computer (PC) and then displays the search result on the personal computer (PC). Alternatively, if the file button has been pressed and the user inputs the voice signal ‘abc’, the controller 180 searches all files, each of which has the word ‘abc’ included in a file name or a text content in the file.

In still another example, after the address book button has been pressed and the user inputs the voice signal ‘abc’, the controller 180 searches all addresses, each of which has the word ‘abc’ included in an address. In another example, after the picture button has been input and the user inputs a voice signal ‘abc’, the controller 180 searches pictures, each of which has the word ‘abc’ included in a picture name or pictures, each of which is related to the search word ‘abc’. Also, after the game button has been input and the user inputs the voice signal ‘abc’, the controller 180 searches all games, each of which has the word ‘abc’ included in a game name, a game help tip or the like.

As mentioned above, if the search range is limited to the prescribed item included in the menu list of the mobile terminal 100, the PC data search operation can be performed more quickly and accurately.

Referring to FIG. 12, if the user selects a prescribed control key (e.g., the power down key) included in the control key set, the interface 1110 can be switched to a new user interface 1210. In particular, if the user selects the power down key, the controller 180 displays the user interface 1210 for setting a power mode of an application executing device to correspond to the input power down key.

In addition, FIG. 12 illustrates that the user interface 1210 includes a control key set having a standby mode key 1221 for entering a standby mode, a power down key 1223 for completely turning off a power of an application executing device and a key 1225 for switching to the user interface 1110.

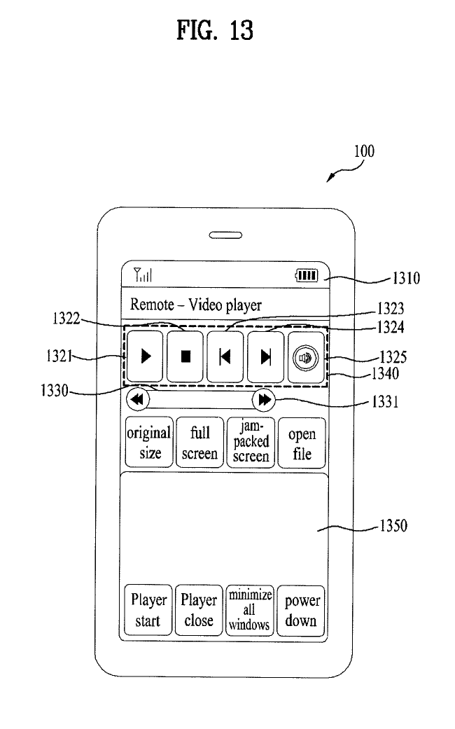

Next, FIGS. 13 to 15 are diagrams of yet another display screen configuration of the mobile terminal 100 according to yet another embodiment of the present invention. In particular, FIGS. 13 to 15 illustrate a display screen implemented by the mobile terminal 100 when the plug-in data corresponding to ‘App3-PC video player’ is selected in FIG. 6 (i.e., when a prescribed application is a video player program).

In addition, in this example, the control key set includes at least one of screen size adjust keys (e.g., original size key, full screen key, jam-packed screen key, etc.), a play key 1321, a stop key 1322, a rewind key 1323, a fast rewind key 1324, a volume adjust key 1325, a search key 1330 for searching for a previous or next scene by manipulating an adjust cursor 1331, a file open key, a player start key, a player close key, an all-window minimize key, a power down key, a touchpad 1350 and the like.

In addition, the play key 1321, the stop key 1322, the rewind key 1323, the fast rewind key 1324 and the volume adjust key 1325, which are control keys used to control a video playback, are referred to as control key item 1340. Thus, when controlling an execution of an application except the video player, the control key item corresponds to a set or group of control keys used to control the execution of the corresponding application.

Moreover, the volume adjust key 1325 can be manipulated by being combined with a motion recognizing sensor. For instance, if the volume adjust key 1325 is pressed or while the volume adjust key 1325 is being pressed, the mobile terminal 100 can be inclined downward to lower a volume or can be inclined upward to raise the volume. Further, the motion recognizing sensor can be included within the sensing unit 140.

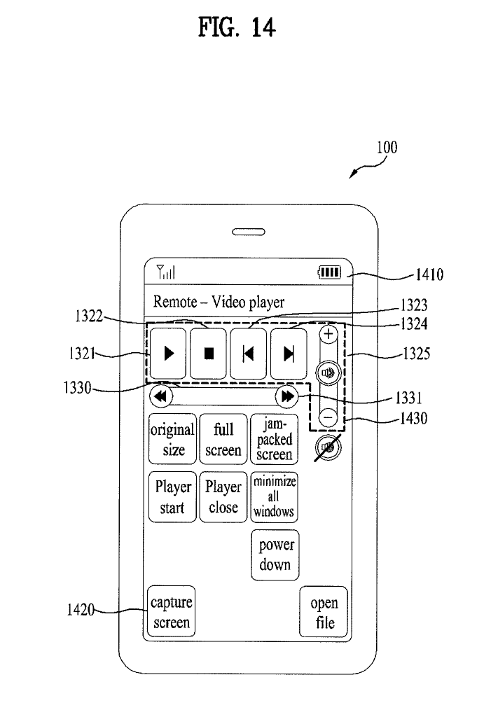

Referring to FIG. 14, a user interface 1410 including a control key set corresponding to a video player differs from the user interface shown in FIG. 13 in type and screen configuration formation. Further, various control keys included in the user interface 1410 are substantially the same to those shown in FIG. 13 and thus their details are omitted from the following description. Also, the key item 1340 shown in FIG. 13 corresponds to a control key item 1430 shown in FIG. 14.

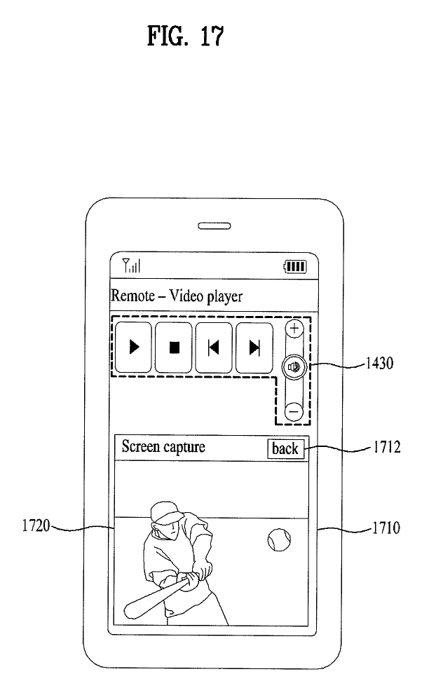

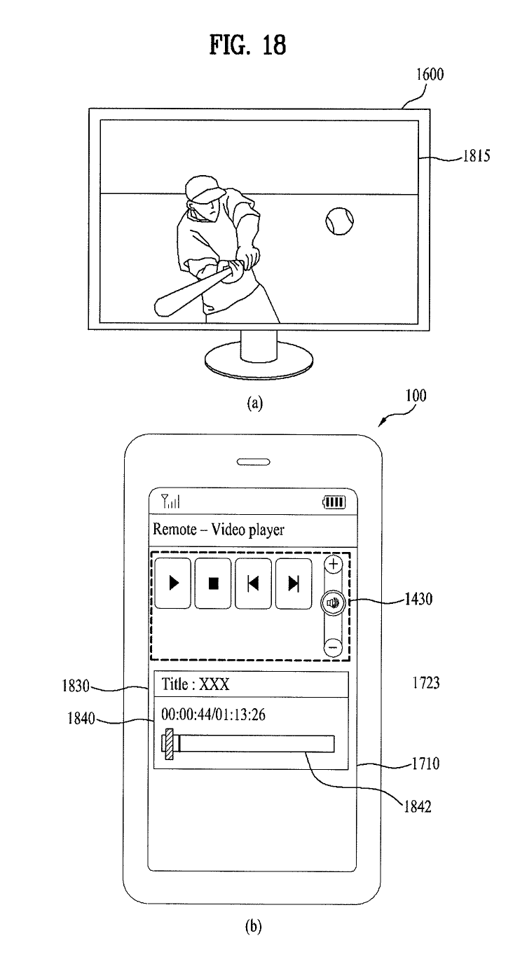

In addition, each of the output user interfaces 1310 and 1410 shown in FIGS. 13 and 14 can further include a screen capture key 1420. The screen capture key 1420 and corresponding control operations thereof will be described in more detail with reference to FIG. 17 later. Also, each of the output user interfaces 1310 and 1410 shown in FIGS. 13 and 14 can further include a progress information key for requesting play progress information on a played video content. The progress information key and corresponding control operations thereof will be described in detail with reference to FIG. 18 later.

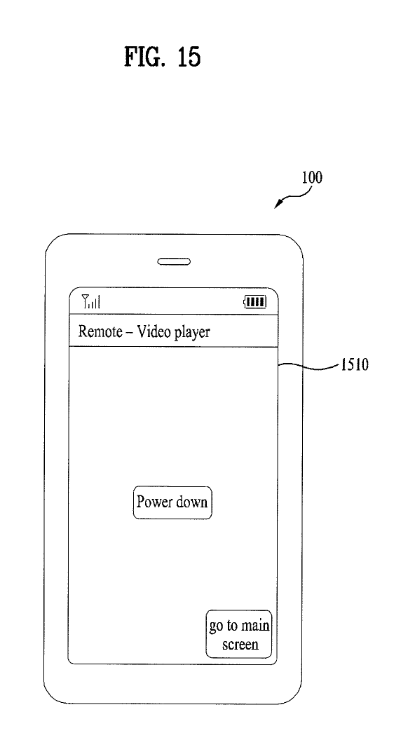

Referring to FIG. 15, in a manner similar to that shown in FIG. 12, the user interface 1310 shown in FIG. 13 can be switched to a new user interface 1510 if a prescribed control key (e.g., a power down key) included in the control key set is input. For instance, if the power down key is input to the controller 180 via the user interface 1310, the controller 180 can display the new user interface 1510 for checking a power mode to correspond to the power down key. In particular, when a control key that is not suppose to be input by mistake such as a control key for turning off a power of an application executing device completely, the user interface 1510 can be displayed for confirming the control key input once more. In addition, the user interface 1510 has the same detailed configuration as shown in FIG. 12 and thus its details are omitted.

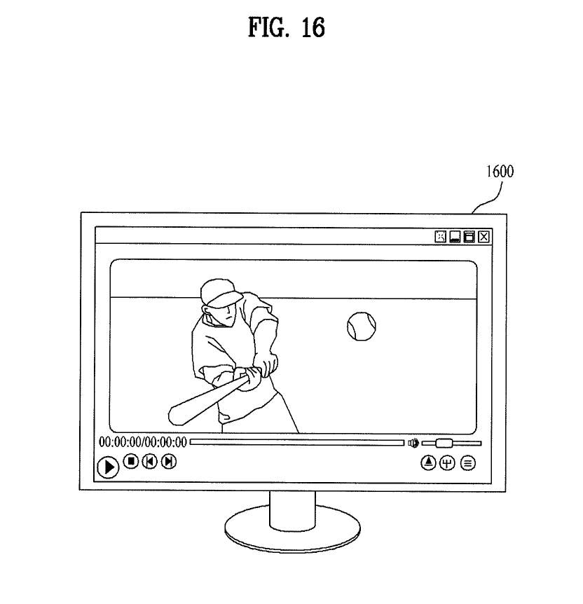

Next, FIG. 16 is an overview of another display screen configuration output by an application executing device controlled by the mobile terminal 100 according to an embodiment of the present invention. Referring to FIG. 16, when the prescribed application is a video play program, a display screen 1610 is output when the prescribed application is executed in an application executing device 1600. In this instance, the application executing device 1600 is a digital television, but can include a personal or notebook computer capable of executing the video play program.

Thus, referring to FIGS. 13 to 16, a user can control an operation of the video player executed in the application executing device 1600 shown in FIG. 16 by manipulating the control key set included in the user interface (e.g., the user interface 1310) output from the mobile terminal 100.

Next, FIG. 17 is an overview of another display screen configuration of the mobile terminal 100 according to an embodiment of the present invention. Also, the screen capture key 1420 shown in FIG. 14 is the key for requesting to capture a video screen played in an application executing device while a video player of an application is being executed. As the user presses the screen capture key 1420, the controller 180 controls the application executing device 1600 to capture and store the displayed screen and can control the stored capture screen to be automatically transmitted to the mobile terminal 100.

Referring to FIG. 17, if the mobile terminal 100 receives the capture screen, the controller 180 can display a captured screen 1720 by being included in a prescribed region of a user interface 1710. Further, the user interface 1710 including the captured screen 1720 can include a control key item 1430. Therefore, the video played via the application executing device 1600 can be conveniently controlled while displaying the captured screen 1720. The user interface including the captured screen 1720 can also include control keys included in a control key set in addition to the necessary control key item 1430.

In addition, the user interface 1710 including the captured screen 1720 can be switched to an original user interface 1310 or 1410 after a prescribed duration (e.g., 5 seconds) set by the controller 180. Alternatively, the user interface 1710 including the captured screen 1720 can include a back key 1712 for returning to the original user interface 1310 or 1410. If the back key 1712 is pressed, the controller 180 can control the original user interface 1310 or 1410 to be output.

Next, FIG. 18 is an overview of another display screen configuration output by an application executing device and another display screen configuration output from the mobile terminal 100 to correspond to the display screen configuration of the application executing device. Referring to FIG. 18(a), if the ‘jam-packed screen’ key is input to the controller 180 via the user interface 1310 or 1410 shown in FIG. 13 or 14, a display screen 1815 is output by the application executing device 1600.

As the jam-packed screen key is input to the controller 180, and if the application executing device 1600 plays a prescribed video content on the entire display screen 1815, a user may want to have information on a progress extent of the played video content. However, outputting the progress information to the display screen 1815 may interrupt the viewing of the prescribed video content.

Thus, referring to FIG. 18(b), according to an embodiment of the present invention, when the controller 180 receives an input of a key of the progress information, the controller 180 enables play progress information 1840 indicating a play progress extent of the played video content to be included in a user interface 1830. Further, the play progress information 1840 can indicate a progress extent of the video content as a ‘total play time to current play time’ and can include a progress bar 1842 indicating the ‘total play time to current play time’. Moreover, the play progress information 1840 can further include at least one of a title of the played video content and basic information (e.g., characters, etc.) of the played video content.

Therefore, the user is provided with the play progress information indicating the progress extent of the currently played content via the mobile terminal 100 by pressing the progress information key and is then facilitated to obtain the play extent without interrupting the viewing of the corresponding video content.

Moreover, the user interface 1830 including the play progress information 1840 can include the control key item 1430. The user interface 1830 including the play progress information 1840 can further include control keys included in the control key set in addition to the control key item 1430. Therefore, the video played via the application executing device 1600 can be controlled with ease while displaying the play progress information 1840.

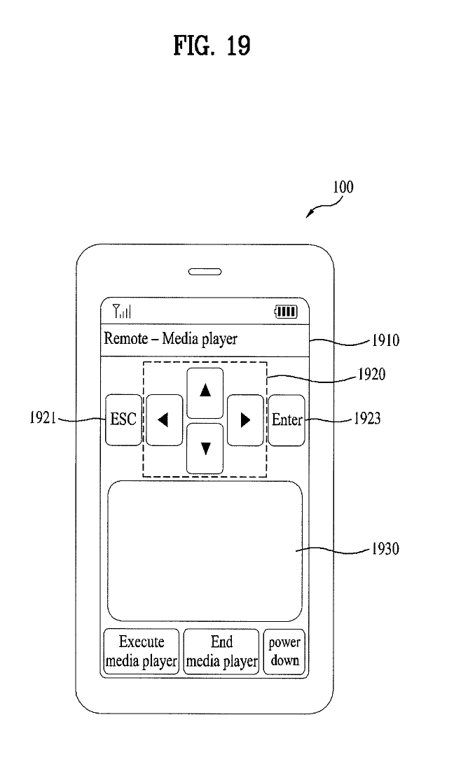

Next, FIG. 19 is an overview of another display screen configuration of the mobile terminal 100 according to an embodiment of the present invention. In FIG. 19, if the user selects the plug-in data corresponding to ‘App2-media player’ in FIG. 6, the controller 180 displays a display screen as shown in FIG. 19. In particular, the prescribed application to execute is a media playback program.

Referring to FIG. 19, the mobile terminal 100 executes the plug-in data corresponding to a media player in accordance with the operation of the step S520 shown in FIG. 5. The controller 180 then displays a user interface 1910 including a control key set corresponding to the media player via the display unit 151. Further, the control key set can include at least one of control keys required for controlling the media player. The control keys include direction shift keys 1920, an Esc key 1921, an enter key 1923, a media player execute key, a media player end key, a power down key and a touchpad 1930. If the user touches and inputs the power down key to the controller 180, the user interface can be switched and output as shown in FIG. 15.

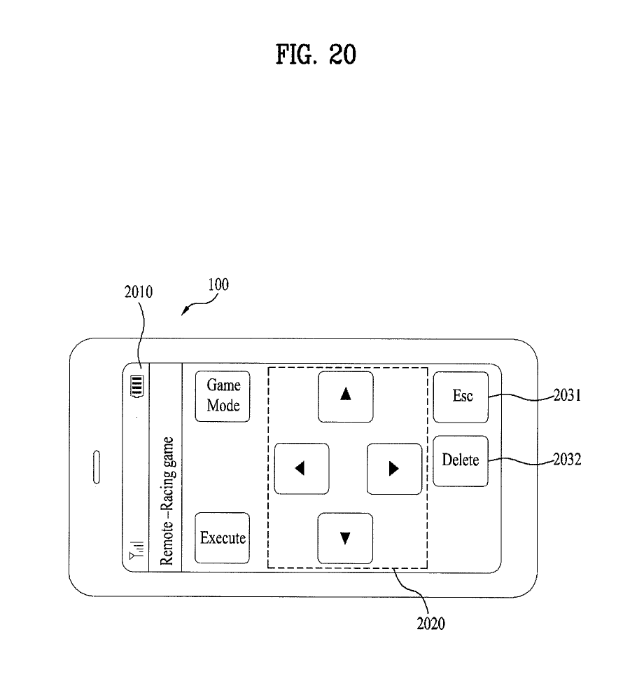

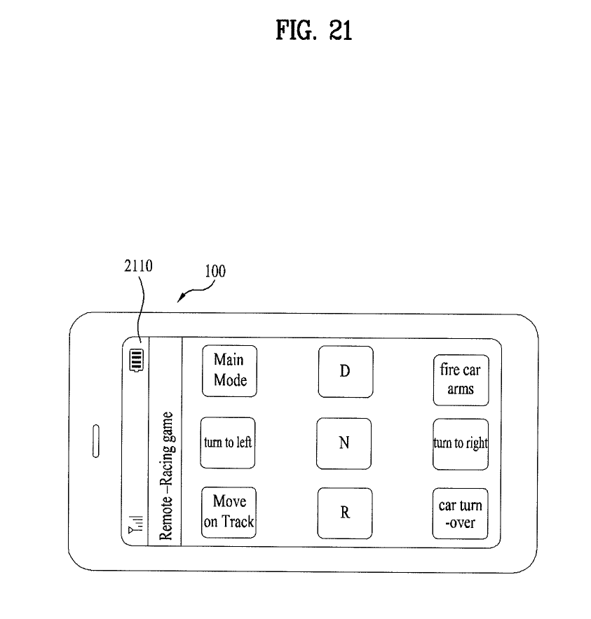

In addition, FIGS. 20 and 21 are overviews of another display screen configuration of the mobile terminal 100 according to an embodiment of the present invention. In FIGS. 20 and 21, when a plug-in data corresponding to a car racing game is executed in the operation of the step S510, the controller 180 displays a display screen shown in FIG. 20.

Referring to FIG. 20, the controller 180 displays a user interface 2010 including a control key set corresponding to a car racing game via the display unit 151. Further, the control key set includes control keys used for executing the car racing game. In more detail, the control keys include a game mode key for requesting a user interface used for playing a game, an execute key for executing a game, a direction adjust key 2020, an Esc key 2031, a delete key 2032 for deleting a previous game record and the like.

Referring to FIG. 21, when the user inputs a prescribed key (e.g., a game mode key), the user interface 2010 shown in FIG. 20 is switched to a new user interface 2110. In particular, when the user inputs a game mode key to the controller 180 via the user interface 2010, the controller 180 displays the new user interface 2110 used for playing a game in response to the key input. Also, FIG. 21 illustrates outputting the user interface 2110 including a control key set having a main mode key for switching to a previous user interface 2010, a key for turning a car to the right, a key for turning a car to the right, a D key for moving a car forward, an N key for holding a car, an R key for moving a car backward, a car arm firing key, a car turn-over key, a Move-on-Track key for requesting to move a car on a track and the like.

Further, a prescribed control key of the user interface 2110 can be interconnected with a motion detecting sensor. For instance, if the mobile terminal 100 is inclined forward when the user touches a drive key at least once or continues to press the drive key, the controller 180 can control a car to move forward. In another instance, if the mobile terminal 100 is inclined backward while the user touches a drive key at least once or continues to press the drive key, the controller 180 can control a car to move backward.

Similarly, if the mobile terminal 100 is maintained on a horizontal level, the controller 180 can control a car to stop, and if the mobile terminal 100 is inclined to the right/left, the controller 180 can control a car to make a right/left turn. Thus, when the control key set having a prescribed control key interconnected with the motion detecting sensor is provided, a simple and convenient user interface can be provided by minimizing the number of control keys provided to the user interface 2110. Moreover, a user can experience the sense of driving a real car.

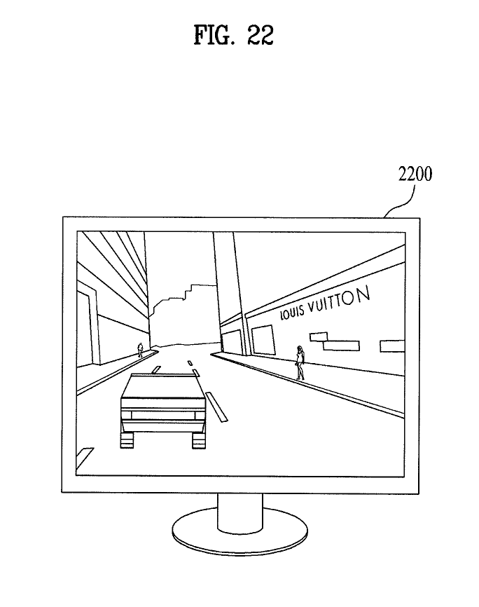

Next, FIG. 22 is an overview of a display screen configuration output by an application executing device controlled by the mobile terminal 100 according to another embodiment of the present invention. Referring to FIG. 22, as the car racing game is executed in an application executing device 2200 (i.e., step S525), a display screen is output on the application executing device 2200.

In more detail, the application executing device 2200 is a device capable of executing the car racing game such as a digital television, a personal computer, a notebook and the like. Referring to FIGS. 20 to 22, the user can manipulate the control key set included in the user interface (e.g., the user interface 2110) output from the mobile terminal 100, to thereby specifically control the car racing game executed in the application executing device 2200 shown in FIG. 22.

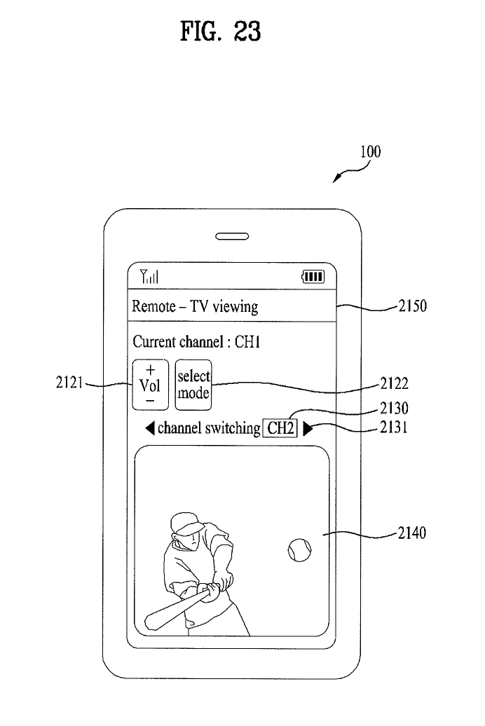

In addition, FIG. 23 is an overview of another display screen configuration of the mobile terminal 100 according to an embodiment of the present invention. Referring to FIG. 23, when the plug-in data corresponding to a broadcast viewing control program in the step S510 is executed (i.e., if a prescribed application to be executed in an application executing device is a broadcast viewing program), the mobile terminal 100 can display a display screen as shown in FIG. 23.

In the following description, a TV (television) viewing application for viewing a TV program including one of a terrestrial broadcast, a cable broadcast and the like is taken as an example of the broadcast viewing application. Referring to FIG. 23, as the controller 180 of the mobile terminal 100 executes the step S520, the controller 180 displays a user interface 2150 including a control key set corresponding to a TV viewing control program via the display unit 151.

In addition, the control key set includes control keys used for controlling the TV viewing. For example, the control keys can include at least one of a volume adjust key 2121, a mode select key 2122 for selecting either a terrestrial broadcast or a cable broadcast, a channel switch key 2130/2131 for specifying a channel to switch to, and a subscreen 2140 for previewing a channel to switch to.

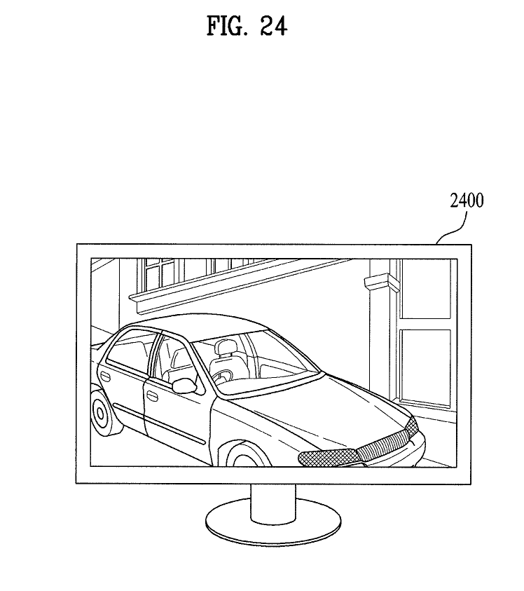

Next, FIG. 24 is an overview of a display screen configuration output by an application executing device controlled by the mobile terminal 100 according to an embodiment of the present invention. In particular, FIG. 24 illustrates a prescribed application is a TV viewing program executed in an application executing device 2400 in accordance with the step S510 shown in FIG. 5. Further, the application executing device 2400 includes a device capable of executing the TV viewing program such as a digital television, a personal computer, a notebook and the like.

Referring to FIG. 24, when the application executing device 2400 displays a video screen provided on a prescribed channel, the controller 180 of the mobile terminal 100 controls a video screen, which is discriminated from the video screen currently displayed in the application executing device 2400, to be displayed via the display unit 151 of the mobile terminal 100. For instance, if a broadcast channel currently displayed in the application executing device 2400 is ‘CH1’, the mobile terminal 100 can display another broadcast channel different from the channel displayed by the application executing device 2400 via a subscreen 2140 as shown in FIG. 23. Thus, the user can preview a broadcast channel he or she wants to switch to via the mobile terminal 100 while watching the original program on the device 2400, thereby allowing the user to more efficiently switch channels.

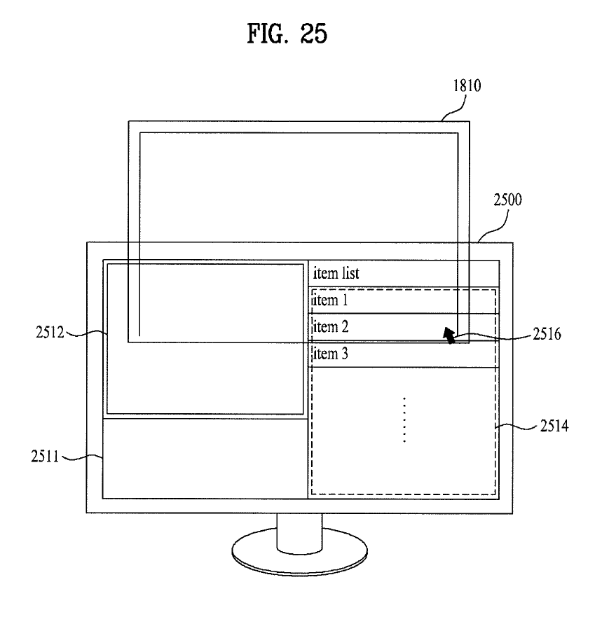

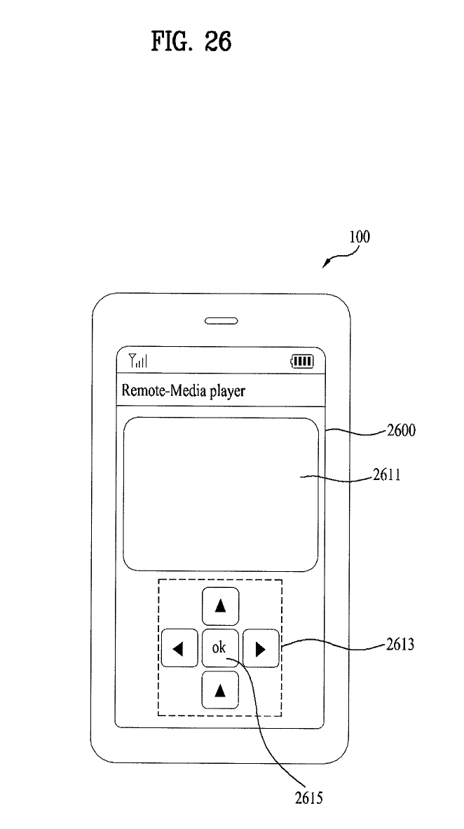

Next, FIG. 25 is an overview of a display screen configuration output by an application executing device controlled by the mobile terminal 100 according to still another embodiment of the present invention. Also, FIG. 26 is an overview of a display screen configuration output by the mobile terminal 100 to correspond to the display screen configuration shown in FIG. 25.

First, referring to FIG. 5, if an executed status of the application executed in the application executing device 501 is changed (S540), the controller 180 of the mobile terminal 100 displays a user interface, which is changed to cope with the change in the step S540 (S550). In addition, the changed user interface output by the mobile terminal 100 includes a control key set for controlling an application execution in the application executing device to match the changed application executed status of the application executing device.

When the change of the step S540 occurs, the application executing device notifies the occurrence of the change to the mobile terminal 100. Accordingly, the controller 180 of the mobile terminal 100 recognizes the change of the step S540 and then displays the changed user interface. Moreover, the controller 180 can periodically monitor the executed status of the application executed in the application executing device. In this instance, the controller 180 controls the change of the step S540 based on the monitoring result and outputs the changed user interface. The above-described operations in the steps S540 and S550 will now be explained in more detail with reference to FIGS. 25 and 26.

Referring to FIG. 25, a prescribed video content is played in the application executing device 2500. If the playback of the video content is completed, the application executing device 2500 can automatically output a content list 2514 for a playback of another video content on a display screen 2511. In particular, according to an application executed status change, the application executing device 2500 switches the display screen shown in FIG. 16 to the display screen 2511 shown in FIG. 25. Further, the display screen 2511 can include a subscreen 2512 for displaying a sample image of the video content corresponding to an item (e.g., item 2) pointed out by a select cursor 2516.

Referring to FIG. 26, if an executed status of an application (e.g., an application for playing a prescribed video content) is switched to ‘play complete’ from ‘play’, the controller 180 displays a user interface 2600 including a control key set used for selecting a prescribed content from the content list 2514. In particular, the controller 180 switches and outputs the user interface 1310 or 1410 shown in FIG. 13 or 14 to the user interface 2600 shown in FIG. 26.

The user interface 2600 also includes a control key set 2613 having directional shift and select keys 2615 for selecting a prescribed content from the content list 2514 displayed in the application executing device 1600. In addition, the user interface 2600 can include a touchpad 2611 for shifting the select cursor 2516. Further, as the mobile terminal 100 performs the step S550, a user interface can be output while being flexibly changed to fit into an executed status change of an application executed in the application executing device 501. Therefore, the user can control the application executed in the application executing device more conveniently and flexibly.

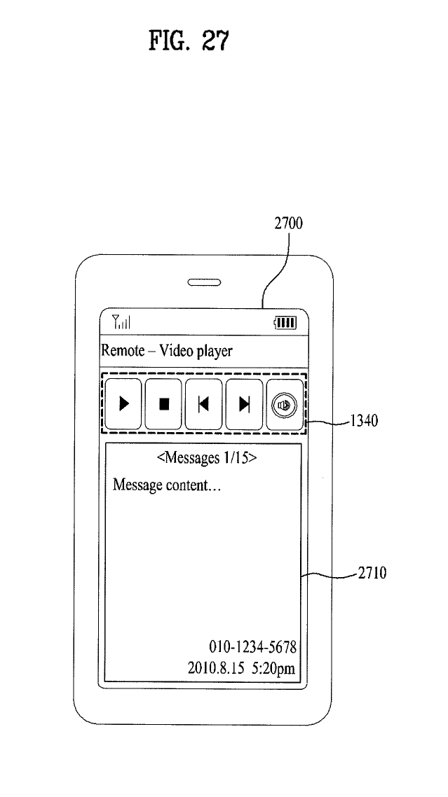

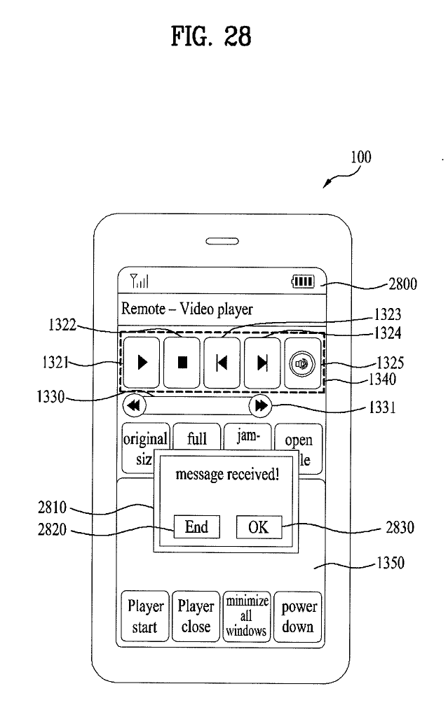

Next, FIGS. 27 and 28 are overviews of a display screen configuration of the mobile terminal 100 according to yet another embodiment of the present invention. However, first referring to FIG. 5, while the mobile terminal 100 performs the application control operation, a mobile communication event can occur (S560). In particular, the mobile communication event can include one of a text message reception, a call reception and the like according to the executed communication function.

If the mobile communication event occurs, the controller 180 keeps performing the previously executed application control operation and simultaneously handles the mobile communication event (S570). In particular, when the mobile communication occurring event is the text message reception, the controller 180 outputs a user interface including control keys having a control key item (e.g., the control key item 1340) and a received text message window 2710. Also, when the mobile communication occurring event is the call reception, the controller 180 can automatically connect a received call while maintaining an output of the user interface (e.g., the user interface 1310 shown in FIG. 13) output before the call reception.

FIG. 27 also illustrates a text message being received while the video player is controlled, as mentioned with reference to FIG. 23. Referring to FIG. 27, the controller 180 can display a user interface 2700 including the control key item 1340 for controlling the video player and the window 2710 for outputting the received message. The controller 180 also changes the user interface 2700 into the formerly output user interface (e.g., the user interface 1310 shown in FIG. 13) and displays the corresponding user interface after a prescribed setting time (e.g., 5 seconds).

Referring to FIG. 28, the controller 180 outputs a confirm message 2810 for handling the mobile communication event (S570). FIG. 28 illustrates the mobile communication event being the message reception. Further, the confirm message 2810 includes an end key 2820 and a confirm key 2830. If the controller 180 receives an input of the end key 2820, the text message window 2710 is not output. On the contrary, if the controller 180 receives an input of the confirm key 2820, the text message window 2710 is output.

As mentioned in above with reference to FIGS. 6 to 28, the mobile terminal 100 executes a stored plug-in data and controls an application corresponding to the plug-in data to be automatically executed in a prescribed application executing device. Further, the mobile terminal 100 provides a control key set optimized for the application executed in the application executing device and facilitates a user to control an application execution in the application executing device via the mobile terminal 100.

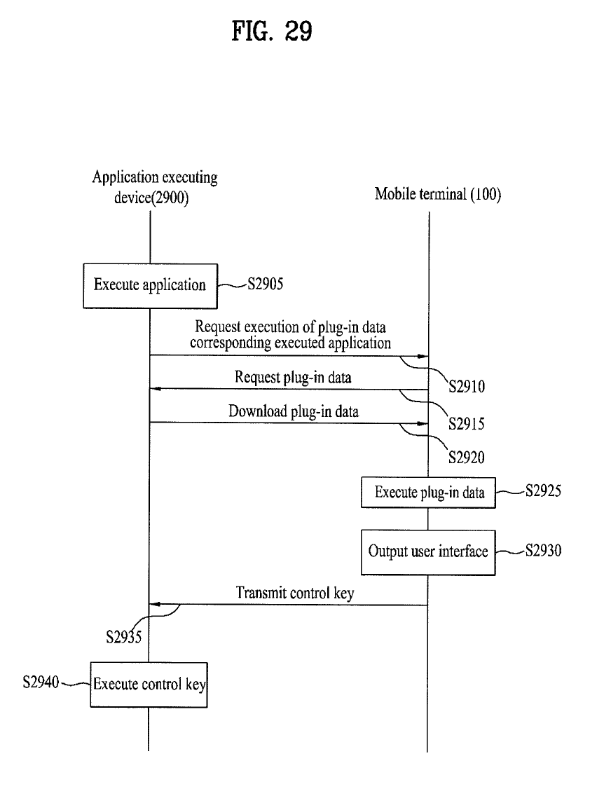

Next, FIG. 29 is a flow diagram illustrating an operation of the mobile terminal 100 according to another embodiment of the present invention. In this embodiment, a prescribed application is executed in an application executing device 2900, and the controller 180 controls a plug-in data corresponding to the prescribed application to be executed in response to the application execution.

In particular, referring to FIG. 29, the prescribed application is executed in the application executing device 2900 (e.g., the application executing device 2900 corresponds to one of the application executing devices shown in FIG. 5) (S2905). Accordingly, the application executing device 2900 sends a request for an execution of a prescribed plug-in data corresponding to the prescribed application to the mobile terminal 100 connected via a wireless communication network (S2910).

In response to the request in the step S2910, the controller 180 requests the plug-in data from the device 2900 (S2915), the device 2900 downloads the plug-in data to the mobile terminal 100 (S2920), and the controller 180 executes the prescribed plug-in data (S2925). The controller 180 then displays a user interface including a control key set corresponding to the prescribed application (S2930).

Further, the controller 180 transmits a control key included in the control key set to the application executing device 2900 (S2935). Accordingly, the application executing device 2900 executes the request or command according to the received control key (S2940). The operations of the steps S2930, S2935 and S2940 are similar to those of the steps S520, S530 and S535 described with reference to FIG. 5, and thus their details are omitted.

In addition, if the prescribed plug-in data is not stored in the memory 160, the controller 180 having received the request in the step S2910 can make a request for a transmission of the prescribed plug-in data to the device 2900 as discussed above (S2915). Although FIG. 29 illustrates the request is transmitted to the application executing device 2900, the request can be provided to all of the above-mentioned providers of the plug-in data. Therefore, the controller 180 can download the prescribed plug-in data from the provider of the plug-in data and enable the downloaded plug-in data to be stored in the memory 160.

Alternatively, the application executing device 2900 can execute the prescribed application (S2905) and automatically transmit a plug-in data corresponding to the executed application to the mobile terminal 100. Accordingly, the mobile terminal 100 can receive the automatically transmitted plug-in data. The mobile terminal 100 can then execute the received plug-in data (S2925).

As mentioned in the above description with reference to FIG. 29, the mobile terminal 100 automatically executes a plug-in data in response to a prescribed application execution in an application executing device 2900, thereby facilitating the application executing device 2900 to be controlled via the mobile terminal 100. Further, the operations shown in FIG. 29 can be performed separately from the former operations shown in FIG. 5. The operations shown in FIG. 29 can also be performed before the step S505 shown in FIG. 5 or after the step S535 shown in FIG. 5.

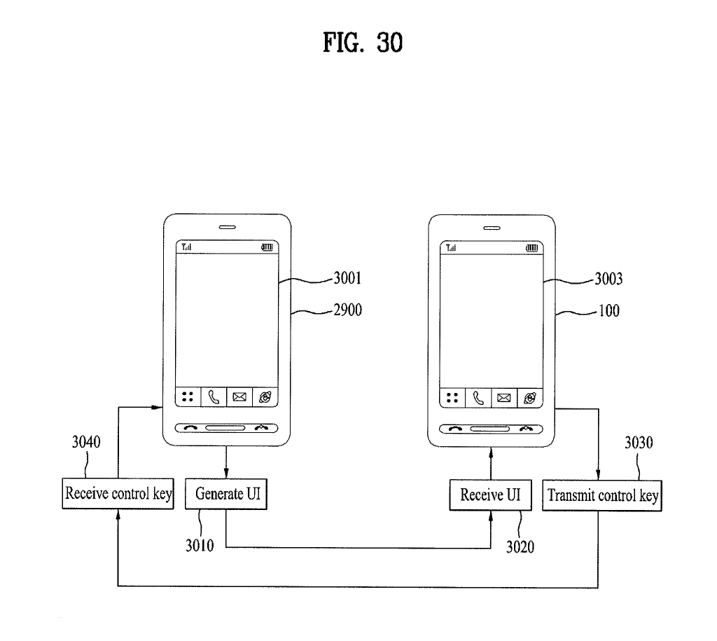

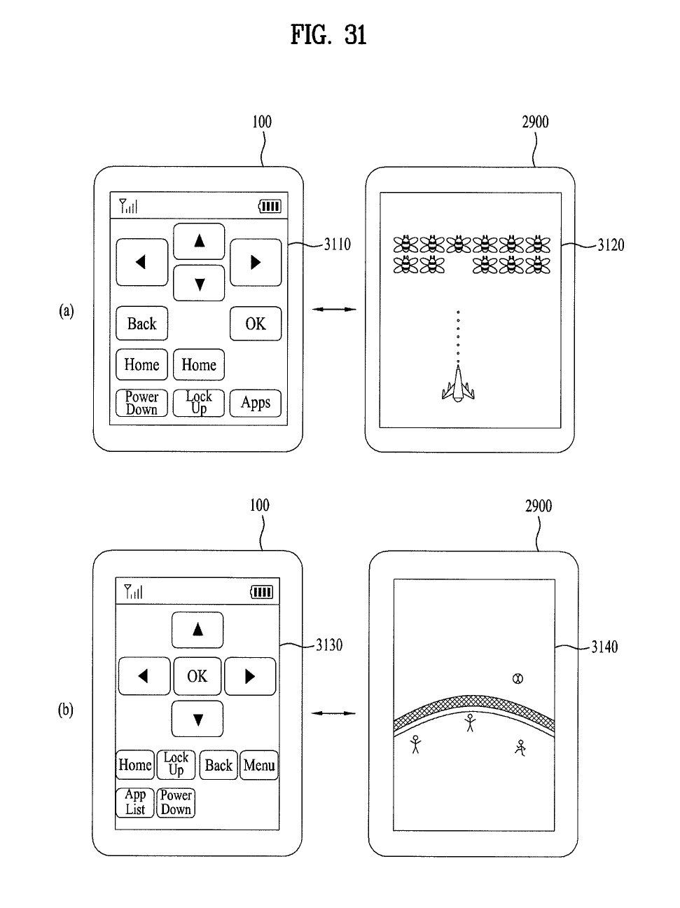

In the following description, the operations described with reference to FIG. 29 are explained in more detail with reference to FIGS. 30 and 31, which illustrate that an application executing device 2900 is a mobile terminal. In more detail, FIG. 30 is an overview illustrating interactive operations between the mobile terminal 100 and an application executing device (which is also a mobile terminal) controlled by the mobile terminal 100.

Referring to FIGS. 29 and 30, as an application executing device 2900 executes a prescribed application (S2905), an executed screen of the prescribed application is displayed on a display unit 3001. Further, a user interface (UI) for controlling an application is then generated (3010). For instance, if the application is a game application, the application executing device 2900 displays a game screen on the display unit 3001, generates a user interface including a control key set for controlling the displayed game, and then transmits the generated user interface to the mobile terminal 100.

The application executing device 2900 then makes a request for executing a corresponding plug-in data (S2910) and transmits data including the generated user interface, simultaneously. The mobile terminal 100 receives the user interface (3020), and displays a user interface 3003 included in the received data (S2930). As mentioned above, the mobile terminal 100 outputs the user interface including the control key set for controlling the game.

A user then selects a control key for controlling the application executed in the application executing device 2900 using the user interface output from the mobile terminal 100 (S2935), and the application executing device 2900 receives the control key (3040) and then executes a corresponding operation (S2940).

Meanwhile, as various types of mobile terminals are continuing being released and used, a game or the like is performed using two mobile terminals simultaneously. For instance, a game screen is displayed on one mobile terminal and a displayed game is controlled using the other mobile terminal. In this instance, a user interface for controlling an application is optimized for the application (e.g., a game application) executed in the application executing device 2900 and the optimized user interface can be then provided to the mobile terminal 100.

Next, FIG. 31 is an overview of a display screen configuration output by an application executing device and a display screen configuration output from a mobile terminal to correspond to the display screen configuration of the application executing device. When various execution levels of an application exist, the application executing device 2900 outputs a different application executed screen per level and the mobile terminal 100 can output a user interface differing per level.

In particular, when the application described with reference to FIG. 30 is a game, for example, FIG. 31 shows a display screen output by the mobile terminal 100 and a display screen output by the application executing device 2900. Referring to FIG. 31(a), the application executing device 2900 outputs a game screen 3120 and the mobile terminal 100 correspondingly outputs a user interface screen 3110 for controlling the game executed by the application executing device 2900.

If several levels of the game executed by the application executing device 2900 exist according to difficulty level of the game, the application executing device 2900 can output a different game screen 3120 per level. Moreover, the mobile terminal 100 can output a different user interface screen 3110 per step of the game.

In particular, when the game level is level 1, if the display screen shown in FIG. 31(a) is output, the game level is changed into another level (e.g., level 2) to output a user interface screen different from the display screen shown in FIG. 31(a). Also, referring to FIG. 31(b), if the game level is level 2, the mobile terminal 100 outputs a user interface screen 3130. If the game level is level 2, the application executing device 2900 outputs a user interface screen 3140. Thus, with reference to FIG. 31, as a different user interface screen per execution level is output, a user becomes less bored in using a single application continuously.

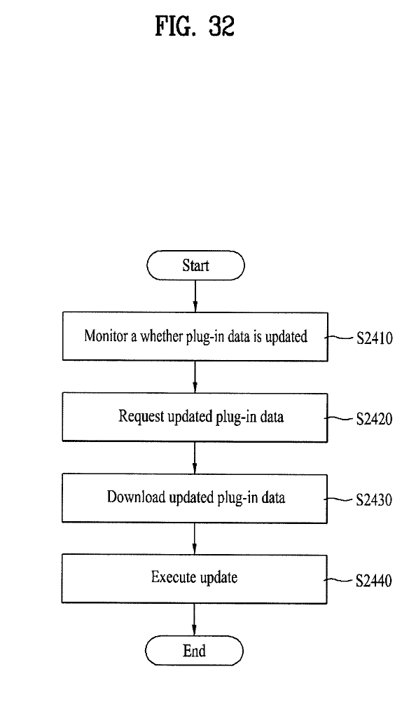

Next, FIG. 32 is a flowchart illustrating an additional operation of a mobile terminal according to an embodiment of the present invention. Referring to FIG. 32, the mobile terminal 100 can monitor a presence or non-presence of an update of plug-in data. In particular, the controller 180 can monitor a presence or non-presence of an update of a plug-in data in a prescribed period interval (S2410).

That is, the controller 180 periodically accesses a plug-in data provider server for providing the plug-in data (e.g., the manufacturer of the mobile terminal 100, the user of the mobile terminal 100, the service provider for providing an application to the mobile terminal 100, the server of the manufacturer of the application executing device, etc.) via the wireless communication unit 110, thereby being able to monitor a presence or non-presence of the update.

The controller 180 then checks whether there is a plug-in data corresponding to a new application not stored in the memory 160 or whether there is an updated plug-in data among the previously stored plug-in data. As a result of the monitoring, if there is the updated plug-in data, the controller 180 makes a request for a transmission of the updated plug-in data to the server that provides the plug-in data (S2420). In response to the step S2420, the controller 180 downloads the updated plug-in data (S2430), and updates the previous plug-in data stored in the memory 160 in accordance with the downloaded plug-in data (S2440).

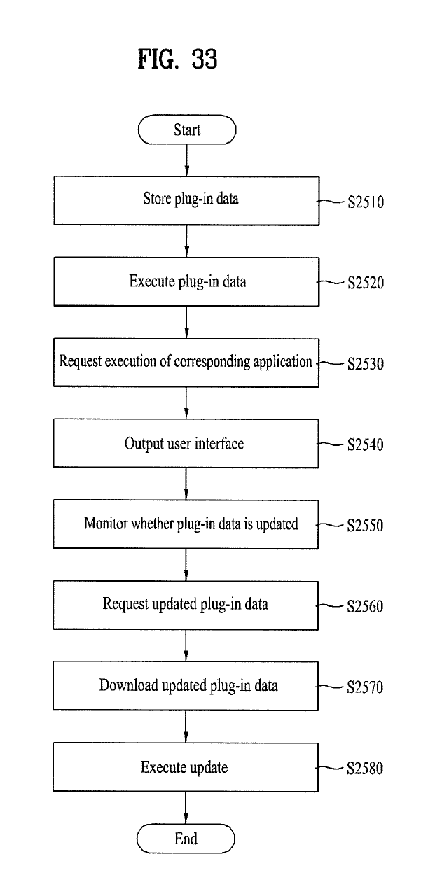

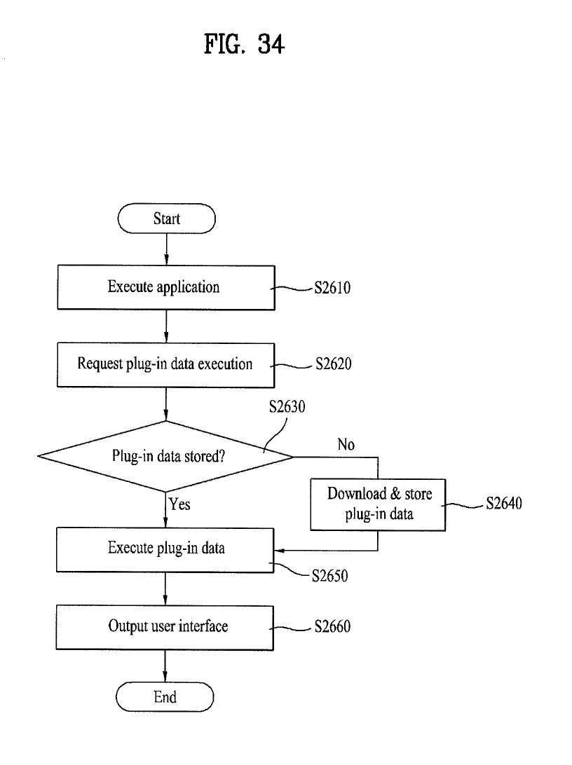

Next, FIGS. 33 and 34 are flowcharts illustrating a method of controlling an application according to an embodiment of the present invention. Referring to FIG. 33, at least one prescribed plug-in data is stored in the mobile terminal (S2510). Further, the plug-in data can include a control key set including control keys used for executing or controlling an application corresponding to the plug-in data.

In addition, the stored prescribed plug-in data is executed (S2520). In particular, the execution can be performed in response to a user's request via a user interface. As the prescribed plug-in data execution of the mobile terminal 100 is performed, a prescribed application is executed in at least one of a plurality of application executing devices connected to the mobile terminal 100 via a wireless communication network (S2530). The prescribed application includes an application corresponding to the prescribed plug-in data.

Before the step S2530, the application controlling method according to an embodiment of the present invention can further include a step of selecting at least one application executing device to execute the prescribed application from a plurality of the application executing devices connected to the mobile terminal 100 via the wireless communication network.

The mobile terminal 100 then outputs a user interface including a control key set (S2540). The application controlling method can further include the steps S2550, S2560, S2570 and S2580 of monitoring a presence or non-presence of an update of the plug-in data and then storing the corresponding updated plug-in data in the mobile terminal 100. In this instance, the steps S2550, S2560, S2570 and S2580 correspond to the steps S2410, S2420, S2430 and S2440 described with reference to FIG. 32 and thus their details are omitted.

Referring to FIG. 34, at least one of a plurality of application executing devices connected to the mobile terminal 100 via a wireless communication network executes a prescribed application (S2610). As the prescribed application is executed in the step S2610, the corresponding application executing device makes a request for an execution of a prescribed plug-in data corresponding to the prescribed application to the mobile terminal 100 (S2620).

If the prescribed plug-in data is stored in the memory 160 of the mobile terminal 100 (Yes in S2630), the mobile terminal 100 executes the prescribed plug-in data (S2650). If the prescribed plug-in data is not stored in the memory 160 of the mobile terminal 100 (No in S2630), the prescribed plug-in data is downloaded from a provider server of the prescribed plug-in data and the downloaded plug-in data is then stored (S2640). Subsequently, the corresponding prescribed plug-in data is executed (S2650). A control key set included in the prescribed plug-in data is then output via a user interface (S2660).

Accordingly, the present invention provides the following advantages. First, an embodiment of the present invention stores and executes a plug-in data corresponding to an application, thereby enabling the application to be automatically executed in at least one application executing device.

Second, an embodiment of the present invention stores and executes a plug-in data corresponding to an application, thereby providing a user interface optimized for each executed application.

Third, an embodiment of the present invention conveniently controls an application executed in an application executing device using a mobile terminal.

Further, according to one embodiment of the present invention, the above-described application controlling methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). The computer can include the controller 180 of the terminal.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal, comprising:
a display unit configured to display information related to the mobile terminal;
a wireless communication unit configured to wirelessly communicate with an external application executing device via a wireless communication network;
a memory configured to store at least one plug-in data corresponding to a specific application; and
a controller configured to execute the plug-in data and to control the specific application to be executed on the external application executing device.

2. The mobile terminal of claim 1, wherein the controller is further configured to control the display unit to display a user interface (UI) including a control key set with at least two control keys for controlling the execution of the specific application on the external application executing device.

3. The mobile terminal of claim 2, wherein the controller is further configured to receive an event related to the mobile terminal, and to simultaneously display the UI and processed information of the event related to the mobile terminal.

4. The mobile terminal of claim 2, wherein when a specific control key included in the control key set is selected, the controller is further configured to execute an operation corresponding to the input control key on the application executing device.

5. The mobile terminal of claim 2, wherein when the specific application executed in the external application executing device is a video player for playing a video content, the control key set includes a screen capture key for capturing a screen of the video content played on the external application executing device, and
wherein when the screen capture key is selected, the controller is further configured to control the external application executing device to capture the screen of the played video content via the wireless communication unit and to control the external application executing device to automatically transmit data corresponding to the captured screen to the mobile terminal.

6. The mobile terminal of claim 2, wherein when the specific application executed in the external application executing device is a video player for playing a video content, the control key set includes a progress information key for requesting a display of play progress information of the video content played on the external application executing device, and
wherein when the progress information key is input, the controller is further configured to control the display unit to display the play progress information.

7. The mobile terminal of claim 2, wherein when the specific application executed in the external application executing device is a broadcast viewing control program for viewing a first broadcast program on a first broadcast channel, the control key set includes a channel preview key for requesting a viewing of a second broadcast program on a second channel different than the first channel, and
wherein when the channel preview key is input, the controller is further configured to control the display unit to display the second broadcast program while displaying the first broadcast program on the external application executing device.

8. The mobile terminal of claim 2, wherein the controller is further configured to monitor an executed status change of the specific application executed in the external application executing device via the wireless communication unit, to change the control key set to correspond to the executed status change, and to display the changed control key set.

9. The mobile terminal of claim 2, further comprising:
a microphone configured to receive a voice signal corresponding to at least one control key among the control keys,
wherein when the voice signal is input via the microphone, the controller is further configured to recognize the input voice signal and control the external application executing device to perform an operation corresponding to the recognized voice signal.

10. The mobile terminal of claim 1, further comprising:
a microphone configured to receive a voice signal corresponding to a search word for searching data stored in the external application executing device,
wherein when the voice signal is input via the microphone and a data type for searching is set, the controller is further configured to control the external application executing device to perform the search within the data type.

11. A method of controlling a mobile terminal, the method comprising:
wirelessly communicating, via a wireless communication unit of the mobile terminal, with an external application executing device via a wireless communication network;
storing, in a memory of the mobile terminal, at least one plug-in data corresponding to a specific application;
executing, via a controller of the mobile terminal, the plug-in data; and
executing, via the controller, the specific application on the external application executing device.

12. The method of claim 11, further comprising:
displaying, via a display unit of the mobile terminal, a user interface (UI) including a control key set with at least two control keys for controlling the execution of the specific application on the external application executing device.

13. The method of claim 12, further comprising:
receiving, via the controller, an event related to the mobile terminal; and
simultaneously displaying, on the display unit, the UI and processed information of the event related to the mobile terminal.

14. The method of claim 12, wherein when a specific control key included in the control key set is selected, the method further comprises executing an operation corresponding to the input control key on the application executing device.

15. The method of claim 12, wherein when the specific application executed in the external application executing device is a video player for playing a video content, the control key set includes a screen capture key for capturing a screen of the played video content played on the external application executing device, and
wherein when the screen capture key is selected, the method further comprises controlling the external application executing device to capture the screen of the played video content via the wireless communication unit and controlling the external application executing device to automatically transmit data corresponding to the captured screen to the mobile terminal.

16. The method of claim 12, wherein when the specific application executed in the external application executing device is a video player for playing a video content, the control key set includes a progress information key for requesting a display of play progress information of the video content played on the external application executing device, and
wherein when the progress information key is input, the method further comprises displaying, on the display unit, the play progress information.

17. The method of claim 12, wherein when the specific application executed in the external application executing device is a broadcast viewing control program for viewing a first broadcast program on a first broadcast channel, the control key set includes a channel preview key for requesting a viewing of a second broadcast program on a second channel different than the first channel, and
wherein when the channel preview key is input, the method further comprises displaying the second broadcast program on the display unit while displaying the first broadcast program on the external application executing device.

18. The method of claim 12, further comprising:
monitoring, via the controller, an executed status change of the specific application executed in the external application executing device via the wireless communication unit;
changing the control key set to correspond to the executed status change; and
displaying the changed control key set on the display unit.

19. The method of claim 12, further comprising:
receiving, via a microphone of the mobile terminal, a voice signal corresponding to at least one control key among the control keys,
wherein when the voice signal is input via the microphone, the method further comprises recognizing the input voice signal and controlling the external application executing device to perform an operation corresponding to the recognized voice signal.

20. The method of claim 11, further comprising:
receiving, via a microphone of the mobile terminal, a voice signal corresponding to a search word for searching data stored in the external application executing device,
wherein when the voice signal is input via the microphone and a data type for searching is set, the method further comprises controlling the external application executing device to perform the search within the data type.
